(19) United States
(12) Patent Application Publication
(10) Pub. No.: US 2025/0323816 A1
(43) Pub. Date: Oct. 16, 2025

(54) RECEIVER FOR REORDERING RECEPTION SIGNAL

(71) Applicant: Samsung Electronics Co., Ltd., Suwon-si (KR)

(72) Inventors: Soonwoo Choi, Suwon-si (KR); Junyoung Jeong, Suwon-si (KR); Myeongjin Kim, Suwon-si (KR); Minki Ahn, Suwon-si (KR); Juhyung Lee, Suwon-si (KR)

(21) Appl. No.: 19/097,960

(22) Filed: Apr. 2, 2025

(30) Foreign Application Priority Data
Apr. 16, 2024 (KR) 10-2024-0050906
May 22, 2024 (KR) 10-2024-0066554

(51) Int. Cl. H04L 27/26

(52) U.S. Cl. CPC H04L 27/26524

(57) ABSTRACT

A receiver according to the present disclosure includes: a fast fourier transform (FFT) processor configured to receive a signal including a plurality of first symbols, and configured to output a plurality of second symbols corresponding to a result of performing a fast fourier transform operation on the signal; a FFT reorder buffer memory configured to store a plurality of third symbols in which the plurality of second symbols are reordered according to a natural order; and a FFT buffer controller configured to control the FFT reorder buffer memory to read the plurality of third symbols according to a circular shift order in which bits of addresses of the FFT reorder buffer memory are circularly shifted.

### CROSS-REFERENCE TO RELATED APPLICATION

This application claims priority to and the benefit of Korean Patent Application No. 10-2024-0050906 filed at the Korean Intellectual Property Office on Apr. 16, 2024, and Korean Patent Application No. 10-2024-0066554 filed in the Korean Intellectual Property Office on May 22, 2024, the entire contents of which are incorporated herein by reference.

### BACKGROUND OF THE INVENTION

The present disclosure relates to a receiver for reordering a reception signal.

To support augmented reality (AR), virtual reality (VR), or the like that requires high throughput, a WiFi standard is developing from 802.11ax (WiFi 6) to 802.11be Extremely High Throughput (EHT) (WiFi 7). With the development of 802.11be EHT (WiFi 7), a bandwidth of the WiFi standard is up to 320 MHz, and a constellation point increases to 4096-QAM that is 1.2 times higher than an existing 1024-QAM. Therefore, in order to support a new WiFi standard, a hardware structure of the WiFi standard requires higher frequency, complexity, and power consumption than those of a conventional hardware structure.

### SUMMARY OF THE INVENTION

Embodiments provide a receiver that reorders a reception signal to improve a speed at which duplication symbols are combined.

A receiver according to some embodiments includes a fast fourier transform (FFT) processor configured to receive a signal including a plurality of first symbols, and configured to output a plurality of second symbols corresponding to a result of performing a fast fourier transform operation on the signal; a FFT reorder buffer memory configured to store a plurality of third symbols in which the plurality of second symbols are reordered according to a natural order; and a FFT buffer controller configured to control the FFT reorder buffer memory to read the plurality of third symbols according to a circular shift order in which bits of addresses of the FFT reorder buffer memory are circularly shifted.

A receiver according to some embodiments includes a fast fourier transform (FFT) processor configured to receive a signal including symbols with a natural order, and configured to output symbols with a bit-reversed order corresponding to a result of performing a fast Fourier transform operation on the signal; and a FFT buffer controller configured to reorder the symbols with the bit-reversed order into symbols with a circular shift order, generate status data of each of the symbols with the circular shift order, and continuously combine status data of duplication symbols among the symbols with the circular shift order.

A communication system according to some embodiments includes a transmitter configured to transmit a signal including a plurality of symbols; and a receiver configured to receive the signal, perform a fast fourier transform (FFT) operation on the signal, reorder the plurality of symbols included in the signal according to a circular shift order, generate status data of each of the plurality of symbols according to the circular shift order, and generate combined status data corresponding to duplication symbols among the plurality of symbols.

### BRIEF DESCRIPTION OF THE DRAWINGS

FIG. 1 is a communication system including a transmitter and a receiver according to some embodiments.

FIG. 2 is a transmitter according to some embodiments.

FIG. 3 is a receiver according to some embodiments.

FIG. 4 illustrates processing of a reception signal with a bit-reversed order output by a fast Fourier transform (FFT) processor according to some embodiments.

FIG. 5 is an FFT buffer controller that reorders a reception signal with a bit-reversed order into a reception signal with a natural order based on an address with a bit-reversed order according to some embodiments.

FIG. 6 illustrates a bit reversal circuit that generates an address with a bit-reversed order according to some embodiments.

FIG. 7 is the FFT buffer controller that generates status data based on a reception signal with a natural order according to some embodiments.

FIG. 8 is a duplication combiner that combines status data with a natural order according to some embodiments.

FIG. 9 is a timing diagram for describing an operation of the duplication combiner according to some embodiments.

FIG. 10 is a timing diagram for describing the duplication combiner that combines the status data with the natural order in an EHT DUP MODE with 320 MHZ according to some embodiments.

FIG. 11 is a timing diagram for describing the duplication combiner that combines the status data with the natural order in a non-HT DUP MODE with 320 MHZ according to some embodiments.

FIG. 12 is the FFT buffer controller that reorders a reception signal with a natural order into a reception signal with a circular shift order based on an address with a circular shift order according to some embodiments.

FIG. 13 illustrates a bit circular shift circuit that generates the address with the circular shift order according to some embodiments.

FIG. 14 illustrates the duplication combiner that combines status data with a circular shift order according to some embodiments.

FIG. 15 is a timing diagram for describing the duplication combiner that combines the status data with the circular shift order according to some embodiments.

FIG. 16 is a timing diagram for describing the duplication combiner that combines the status data with the circular shift order in an EHT DUP MODE with 320 MHz according to some embodiments.

FIG. 17 is a timing diagram for describing the duplication combiner that combines the status data with the circular shift order in a non-HT DUP MODE with 320 MHz according to some embodiments.

FIG. 18 is a bit inversion relationship between the natural order, the bit-reversed order, and the circular shift order according to some embodiments.

FIG. 19 is a timing diagram for describing the receiver that reorders reception symbols included in the reception signal according to some embodiments.

FIG. 20 is the receiver that determines a new channel response value based on a Log Likelihood Ratio (LLR) and the combined status data according to some embodiments.

FIG. 21 illustrates operations of the receiver that performs a channel tracking operation based on the reception signal with the natural order according to some embodiments.

FIG. 22 illustrates operations of the receiver that performs a channel tracking operation based on the reception signal with the circular shift order according to some embodiments.

FIG. 23 is a graph of a signal-to-noise ratio (SNR) and a packet error rate (PER) according to the channel tracking operation according to some embodiments.

FIG. 24 is a communication device according to some embodiments.

FIG. 25 is a system-on-chip according to some embodiments.

### DETAILED DESCRIPTION OF THE EMBODIMENTS

Embodiments of the present disclosure will be described more fully hereinafter with reference to the accompanying drawings so that those skilled in the art easily implement the embodiments. The present disclosure may be modified in various different ways, all without departing from the spirit or scope of the present disclosure.

In order to clearly describe the present disclosure, parts or portions that are irrelevant to the description are omitted, and identical or similar constituent elements throughout the specification are denoted by the same reference numerals.

In addition, unless explicitly described to the contrary, the word “comprise” and variations such as “comprises” or “comprising” will be understood to imply the inclusion of stated elements but not the exclusion of any other elements.

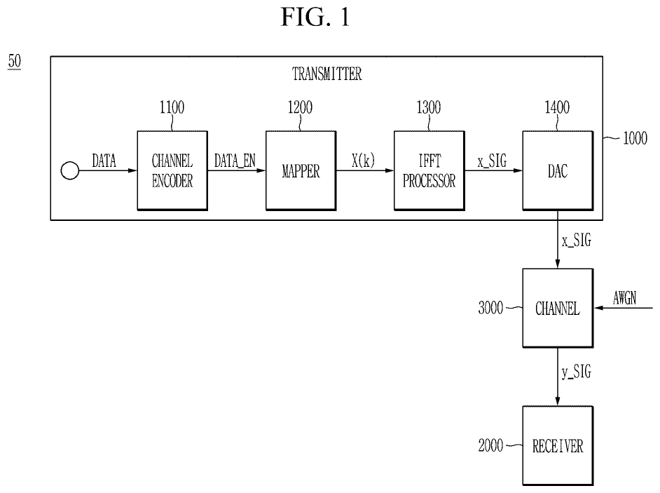

FIG. 1 is a communication system including a transmitter and a receiver according to some embodiments.

Referring to FIG. 1, the communication system 50 may include the transmitter 1000 and the receiver 2000. The transmitter 1000 may transmit a data signal to the receiver 2000 through a channel 3000.

In some embodiments, the transmitter 1000 may include a channel encoder 1100, a mapper 1200, an Inverse Fast Fourier Transform (IFFT) processor 1300, and a Digital to Analog Converter (DAC) 1400.

The channel encoder 1100 may generate encoding data DATA_EN by encoding data (DATA) that is received. The channel encoder 1100 may provide the encoding data DATA_EN to the mapper 1200.

The mapper 1200 may convert the encoding data DATA_EN into a transmission symbol X(k) mapped to a point on a constellation. The transmission symbol X(k) may be a symbol of a frequency domain. The mapper 1200 may provide the transmission symbol X(k) to the IFFT processor 1300.

The IFFT processor 1300 may perform an inverse fast Fourier transform operation on the transmission symbol X(k). The IFFT processor 1300 may convert the transmission symbol X(k) of the frequency domain received from the mapper 1200 into a transmission symbol of a time domain. The IFFT processor 1300 may generate a transmission signal x_SIG including the transmission symbol of the time domain. The transmission signal output by the IFFT processor 1300 may be a signal of the time domain. The IFFT processor 1300 may provide the transmission signal x_SIG of the time domain to the DAC 1400.

The DAC 1400 may convert the transmission signal x_SIG received from the IFFT processor 1300 from a digital signal to an analog signal. The DAC 1400 may transmit the transmission signal x_SIG to the receiver 2000 through the channel 3000.

The transmission signal x_SIG may be distorted by the influence of fading and noise of the channel 3000 while passing through the channel 3000. The receiver 2000 may receive a reception signal y_SIG that is a signal changed as the transmission signal x_SIG passes through the channel 3000, i.e., the signal may be distorted by fading and noise of the channel 3000.

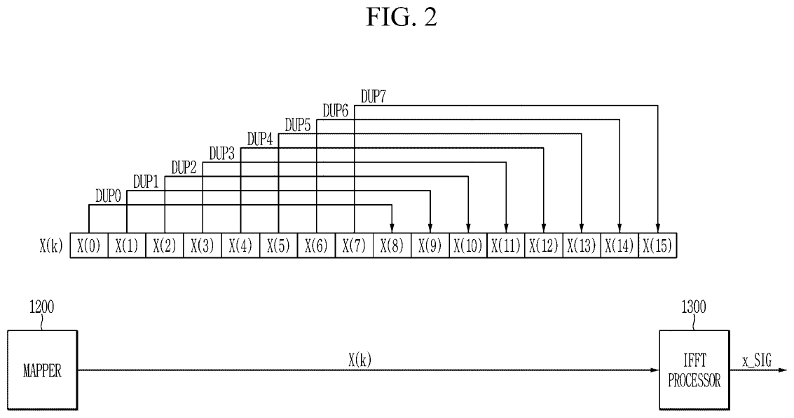

FIG. 2 illustrates operations of the transmitter according to some embodiments.

Referring to FIG. 2, the mapper 1200 may provide a transmission signal including a plurality of transmission symbols to the IFFT processor 1300. In some embodiments, the mapper 1200 may provide 0th to 15th transmission symbols X(0)-X(15) to the IFFT processor 1300. In some embodiments, the 0th to 15th transmission symbols X(0)-X(15) may include duplication symbols.

In some embodiments, the 0th transmission symbol (X(0)) and the 8th transmission symbol (X(8)) may be the duplication symbols. The 0th transmission symbol (X(0)) and the 8th transmission symbol (X(8)) may be the same transmission symbol. Likewise, each of the 1st to 7th transmission symbols X(1)-X(7) and each of the 9th to 15th transmission symbols X(9)-X(15) corresponding to each of the 1st to 7th transmission symbols X(1)-X(7) may be the duplication symbols. The number of the duplication symbols among the 0th to 15th transmission symbols X(0)-X(15) may be “2”, i.e., duplication may occur in pairs with two symbols being duplicates of one another.

In some embodiments, the mapper 1200 may provide the transmission symbols including the duplication symbols to the IFFT processor 1300, and the IFFT processor 1300 may generate the transmission signal x_SIG including the transmission symbols.

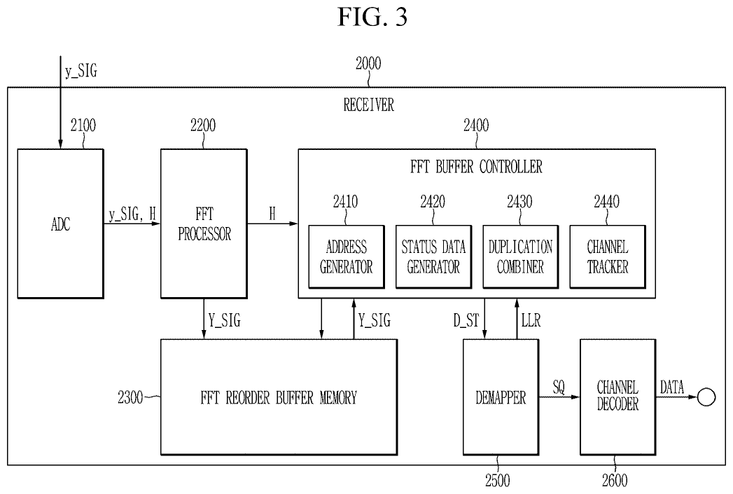

FIG. 3 is the receiver according to some embodiments.

Referring to FIG. 3, the receiver 2000 may include an analog to digital converter (ADC) 2100, a Fast Fourier Transform (FFT) processor 2200, an FFT reorder buffer memory 2300, an FFT buffer controller 2400, a demapper 2500, and a channel decoder 2600.

In some embodiments, the ADC 2100 may receive the reception signal y_SIG. The ADC 2100 may convert the reception signal y_SIG from an analog signal to a digital signal. The reception signal y_SIG converted to the digital signal may include reception symbols. The ADC 2100 may provide the reception symbols included in the reception signal y_SIG to the FFT processor 2200. The ADC 2100 may obtain a channel response value H for the channel 3000 through which the reception signal y_SIG passes. The ADC 2100 may provide the channel response value H to the FFT processor 2200.

In some embodiments, the FFT processor 2200 may perform a fast Fourier transform (FFT) operation on the reception signal y_SIG received from the ADC 2100. The reception signal y_SIG received from the ADC 2100 may be a signal of a time domain. The FFT processor 2200 may convert the reception signal y_SIG of the time domain into the reception signal y_SIG of a frequency domain. The reception signal y_SIG of the frequency domain may include reception symbols of the frequency domain. The FFT processor 2200 may provide the reception signal y_SIG corresponding to a result of performing the fast Fourier transform operation to the FFT reorder buffer memory 2300. The FFT processor 2200 may provide the channel response value H to the FFT buffer controller 2400.

In some embodiments, the reception symbols included in the reception signal y_SIG received from the ADC 2100 may be reception symbols with a natural order (NO). In some embodiments, the natural order may be an order of the reception symbols ordered according to an order in which the transmitter 1000 transmits transmission symbols.

In some embodiments, the FFT processor 2200 may receive the reception symbols with the natural order from the ADC 2100, and may output reception symbols with a bit-reversed order (BRO) as a result of performing a fast Fourier transform operation on the reception symbols with the natural order.

In some embodiments, the bit-reversed order may be an order of the reception symbols in which bits representing an order of the reception symbols are reordered according to an order corresponding to reversely-ordered bits.

In some embodiments, the FFT reorder buffer memory 2300 may store the reception symbols included in the reception signal y_SIG received from the FFT processor 2200. In some embodiments, the FFT reorder buffer memory 2300 may store the reception symbols with the natural order in which reception symbols with the bit-reversed order are reordered according to the natural order. The FFT reorder buffer memory 2300 may store the reception symbols with the bit-reversed order received from the FFT processor 2200 according to the natural order in response to an address with the bit-reversed order received from the FFT buffer controller 2400. The address with the bit-reversed order may be an address including bits in which bits of an address of the FFT reorder buffer memory 2300 are reversely ordered.

In some embodiments, the FFT buffer controller 2400 may store the reception symbols in the FFT reorder buffer memory 2300, or may control the FFT reorder buffer memory 2300 to read the reception symbols stored in the FFT reorder buffer memory 2300.

In some embodiments, the FFT buffer controller 2400 may control the FFT reorder buffer memory 2300 to store the reception symbols with the bit-reversed order output by the FFT processor 2200 in the FFT reorder buffer memory 2300 according to the natural order.

In some embodiments, the FFT buffer controller 2400 may control the FFT reorder buffer memory 2300 to read the reception symbols with the natural order stored in the FFT reorder buffer memory 2300 according to a circular shift order (CSO).

In some embodiments, the FFT buffer controller 2400 may include an address generator 2410, a status data generator 2420, a duplication combiner 2430, and a channel tracker 2440.

In some embodiments, the address generator 2410 may generate the address of the FFT reorder buffer memory 2300. The address generator 2410 may determine the number of bits of the address of the FFT reorder buffer memory 2300 based on a size of the FFT. The size of the FFT may be determined depending on a type of the reception signal y_SIG and a bandwidth of the reception signal y_SIG. In some embodiments, the size of the FFT may be a size at which the FFT processor 2200 performs the fast Fourier transform (FFT) operation.

In some embodiments, the address generator 2410 may generate an address with the natural order including bits determined according to the size of the FFT. In some embodiments, the address generator 2410 may convert the address with the natural order to the address with the bit-reversed order.

In some embodiments, the address generator 2410 may control the FFT reorder buffer memory 2300 so that the FFT reorder buffer memory 2300 stores the reception symbols with the bit-reversed order according to the natural order based on the address with the bit-reversed order.

In some embodiments, the address generator 2410 may convert the address with the natural order to an address with the circular shift order. The address with the circular shift order may be an address in which at least one bit among bits of the address with the natural order includes circularly shifted bits.

In some embodiments, the address generator 2410 may determine the number of bits to be circularly shifted among the bits of the address with the natural order based on the number of the duplication symbols.

In some embodiments, the address generator 2410 may control the FFT reorder buffer memory 2300 to read the reception symbols with the natural order stored in the FFT reorder buffer memory 2300 according to the circular shift order based on the address with the circular shift order.

In some embodiments, the status data generator 2420 may receive the reception symbols with the natural order stored in the FFT reorder buffer memory 2300 according to the circular shift order.

In some embodiments, the status data generator 2420 may generate status data for each reception symbol based on reception symbols with the circular shift order and the channel response value H. The status data generator 2420 may generate status data with the circular shift order. The status data generator 2420 may provide the status data with the circular shift order to the duplication combiner 2430.

In some embodiments, the duplication combiner 2430 may combine status data corresponding to duplication symbols among the reception symbols. The duplication combiner 2430 may provide the combined status data D_ST to the demapper 2500. In some embodiments, the duplication combiner 2430 may receive the status data with the circular shift order, and may sequentially combine the status data corresponding to the duplication symbols.

In some embodiments, the channel tracker 2440 may determine a new channel response value based on the combined status data D_ST and a log likelihood ratio (LLR) received from the demapper 2500. The new channel response value may be used to generate status data corresponding to each reception symbol included in a signal following the reception signal y_SIG.

In some embodiments, the demapper 2500 may calculate the LLR based on the combined status data D_ST. The demapper 2500 may calculate a soft metric based on the reception symbols and the channel response value. The soft metric may be reliability information of each bit for a bit forming a codeword of a channel code. The demapper 2500 may generate a sequence SQ corresponding to a result of calculating the soft metric. The demapper 2500 may provide the sequence SQ to the channel decoder 2600.

In some embodiments, the channel decoder 2600 may generate data (DATA) by decoding the sequence SQ received from the demapper 2500. In some embodiments, the channel decoder 2600 may be an LDPC decoder that decodes a low-density parity-check (LDPC) code.

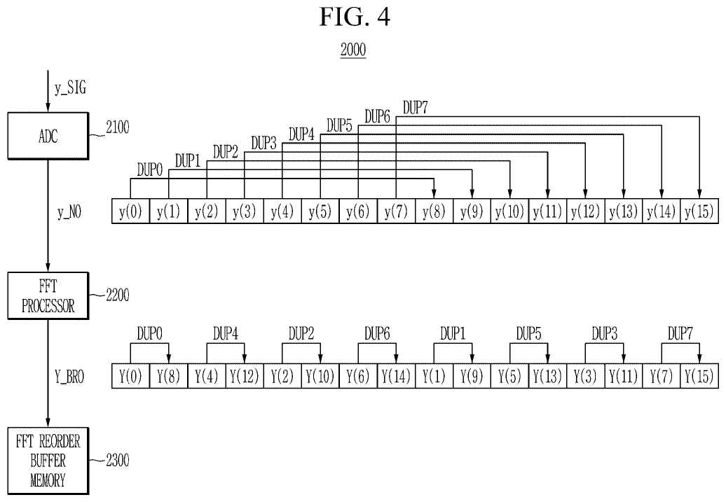

FIG. 4 illustrates processing of a reception signal with the bit-reversed order output by the fast Fourier transform (FFT) processor according to some embodiments.

Referring to FIG. 4, the ADC 2100 may convert the reception signal y_SIG received through the channel from an analog signal to a digital signal. The reception signal that is the digital signal may include the reception symbols. The ADC 2100 may provide a reception signal y_NO with the natural order to the FFT processor 2200. In some embodiments, the reception signal y_NO with the natural order may include 0th to 15th reception symbols y(0)-y(15) with the natural order.

In some embodiments, the 0th reception symbol y(0) and the 8th reception symbol y(8) may be duplication symbols. The 0th reception symbol y(0) and the 8th reception symbol y(8) may be the same reception symbol. Likewise, each of the 1st to 7th reception symbols y(1)-y(7) and each of the 9th to 15th reception symbols y(9)-y(15) corresponding to each of the 1st to 7th reception symbols y(1)-y(7) may be the duplication symbols. The same symbols among the 0th to 15th reception symbols y(0)-y(15) may be two symbols. The number of the duplication symbols among the 0th to 15th reception symbols y(0)-y(15) may be “2” symbols.

The FFT processor 2200 may output a reception signal Y_BRO with the bit-reversed order including reception symbols with the bit-reversed order as a result of performing a fast Fourier transform (FFT) operation on the reception symbols with the natural order.

In some embodiments, if bits indicating a first order are “0001”, the FFT processor 2200 may output the first reception symbol y(1) received in the first order as an eighth order corresponding to “1000” that is bits in which “0001” is reversely ordered.

In some embodiments, if bits indicating the second order are “0010”, the FFT processor 2200 may output the second reception symbol y(2) received in the second order as a fourth order corresponding to “0100” that is bits in which “0010” is reversely ordered.

In some embodiments, the FFT processor 2200 may receive the 0th to 15th reception symbols y(0)-y(15) with the natural order, and may sequentially provide a 0th reception symbol Y(0), an 8th reception symbol Y(8), a 4th reception symbol Y(4), a 12th reception symbol Y(12), a 2nd reception symbol Y(2), a 10th reception symbol Y(10), a 6th reception symbol Y(6), a 14th reception symbol Y(14), a 1st reception symbol Y(1), a 9th reception symbol Y(9), a 13th reception symbol Y(13), a 3rd reception symbol Y(3), an 11th reception symbol Y(11), a 7th reception symbol Y(7), and a 15th reception symbol Y(15) that correspond to the bit-reversed order to the FFT reorder buffer memory 2300.

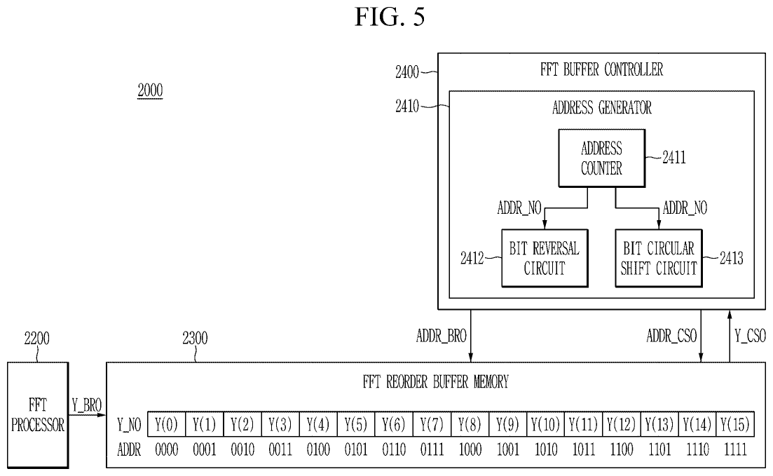

FIG. 5 is the FFT buffer controller.

Referring to FIG. 5, the FFT buffer controller 2400 may control the FFT reorder buffer memory 2300 to store the reception signal Y_BRO with the bit-reversed order output by the FFT processor 2200 according to the natural order. The FFT buffer controller 2400 may control the FFT reorder buffer memory 2300 to read reception symbols with the natural order stored in the FFT reorder buffer memory 2300 according to the circular shift order.

In some embodiments, the FFT buffer controller 2400 may include the address generator 2410. In some embodiments, the address generator 2410 may determine the number of bits of an address of the FFT reorder buffer memory 2300 based on a size of the FFT.

In some embodiments, the FFT size may be determined according to a mode of the reception signal and a bandwidth of the reception signal, as shown in Table 1.

TABLE 1

| MODE | Bandwidth (MHz) | FFT size |
|---|---|---|
| non-HT DUP MODE | 40 | 2⁷ = 128 |
| | 80 | 2⁸ = 256 |
| | 160 | 2⁹ = 512 |
| | 320 | 2¹⁰ = 1024 |
| EHT DUP MODE | 80 | 2¹⁰ = 1024 |
| | 160 | 2¹¹ = 2048 |
| | 320 | 2¹² = 4096 |

In some embodiments, if the reception signal corresponds to a non-High Throughput Duplication Mode (non-HT DUP MODE) with 40 MHz, the FFT size may be “128”. In some embodiments, if the reception signal corresponds to the non-HT DUP MODE with 320 MHz, the FFT size may be “1024”. In some embodiments, if the reception signal corresponds to an Extremely High Throughput Duplication Mode (EHT DUP MODE) with 320 MHZ, the FFT size may be “4096”.

In some embodiments, the address generator 2410 may determine the number of the bits of the address of the FFT reorder buffer memory 2300 according to Equation 1 based on the FFT size.

$$n = {log}_{2} N \qquad ( Equation 1 )$$

In Equation 1, N may be the FFT size. The n may be the number of the bits of the address of the FFT reorder buffer memory 2300.

In some embodiments, as shown in FIG. 4, if the reception signal includes 16 reception symbols, the FFT size may be “16”. The address generator 2410 may determine the number of the bits of the address as “4” according to Equation 1. The address of the FFT reorder buffer memory 2300 may include four bits.

In some embodiments, because the FFT size is “128” if the reception signal corresponds to the non-HT DUP MODE with 40 MHz, the address generator 2410 may determine the number of the bits of the address as “7”.

In some embodiments, because the FFT size is “1024” if the reception signal corresponds to the non-HT DUP MODE with 320 MHz, the address generator 2410 may determine the number of the bits of the address as “10”.

In some embodiments, because the FFT size is “4096” if the reception signal y_SIG corresponds to the EHT DUP MODE with 320 MHz, the address generator 2410 may determine the number of the bits of the address as “12”.

In some embodiments, the address generator 2410 may include an address counter 2411, a bit reversal circuit 2412, and a bit circular shift circuit 2413.

In some embodiments, the address counter 2411 may generate an address ADDR_NO with the natural order including bits determined according to the FFT size. The address counter 2411 may provide the address ADDR_NO with the natural order to the bit reversal circuit 2412 and the bit circular shift circuit 2413.

The address ADDR_NO with the natural order may be expressed as Equation 2.

$${NO}_{n} ( {b}_{n - 1} {b}_{n - 2} … {b}_{1} {b}_{0} ) = {b}_{n - 1} {b}_{n - 2} … {b}_{1} {b}_{0} \qquad ( Equation 2 )$$

In Equation 2, NOₙ may be the address ADDR_NO with the natural ordered including n bits. The address ADDR_NO with the natural order may be an address where the 0th to (n-1)th bits (b₀-bₙ₋₁) include bits ordered from the 0th bit (b₀) to the (n-1)th bit (bₙ₋₁).

In some embodiments, if the FFT size is “1024”, the number of the bits of the address according to Equation 1 may be “10”. The address ADDR_NO with the natural order may include the 0th to 9th bits (b₀-b₉). In some embodiments, if the FFT size is “4096”, the number of the bits of the address according to Equation 1 may be “12”. The address ADDR_NO with the natural order may include the 0th to 11th bits (b₀-b₁₁).

In some embodiments, the bit reversal circuit 2412 may convert the address ADDR_NO with the natural order to an address ADDR_BRO with the bit-reversed order. The address ADDR_BRO with the bit-reversed order may be an address including bits in which bits of the address ADDR_NO with the natural order are reversely ordered (or reversely arranged).

The address ADDR_BRO with the bit-reversed order may be expressed as Equation 3.

$${BRO}_{n} ( {b}_{n - 1} {b}_{n - 2} … {b}_{1} {b}_{0} ) = {b}_{0} {b}_{1} … {b}_{n - 2} {b}_{n - 1} \qquad ( Equation 3 )$$

In Equation 3, BROₙ may be the address ADDR_BRO with the bit-reversed order including n bits. The address ADDR_BRO with the bit-reversed order may be an address where the 0th to (n-1)th bits (b₀-bₙ₋₁) include bits reversely ordered from the (n-1)th bit (bₙ₋₁) to the 0th bit (b₀).

In some embodiments, the bit reversal circuit 2412 may provide the address ADDR_BRO with the bit-reversed order to the FFT reorder buffer memory 2300. The FFT reorder buffer memory 2300 may store the reception signal y_NO with the natural order in which the reception signal Y_BRO with the bit-reversed order received from the FFT processor 2200 is reordered according to the natural order in response to the address ADDR_BRO with the bit-reversed order. The reception symbols with the natural order included in the reception signal y_NO with the natural order may be sequentially stored in the FFT reorder buffer memory 2300.

In some embodiments, the 0th reception symbol may be stored in a position corresponding to “0000” indicating an address with a 0th order. In some embodiments, the 1st reception symbol Y(1) may be stored in a position corresponding to “0001” indicating an address with a 1st order. In some embodiments, the 2nd reception symbol Y(2) may be stored in a position corresponding to “0010” indicating an address with a 2nd order.

In some embodiments, the bit circular shift circuit 2413 may convert the address ADDR_NO with the natural order to an address ADDR_CSO with the circular shift order. The address ADDR_CSO with the circular shift order may be an address in which at least one bit among bits of the address ADDR_CSO with the natural order includes circularly shifted bits.

The address ADDR_CSO with the circular shift order may be expressed as Equation 4.

$${CSO}_{n , d} ( {b}_{n - 1} {b}_{n - 2} … {b}_{1} {b}_{0} ) = {b}_{d - 1} … {b}_{0} {b}_{n - 1} … {b}_{d + 1} {b}_{d} \qquad ( Equation 4 )$$

In Equation 4, CSO_{n,d} may include n bits, and may be the address ADDR_CSO with the circular shift order in which d bits are circularly shifted. The address ADDR_CSO with the circular shift order may be an address including bits in which the 0th to (d-1) th bits (b₀-b_{d-1}) among the 0th to (n-1)th bits (b₀-bₙ₋₁) are circularly shifted.

In some embodiments, the bit circular shift circuit 2413 may determine the number of bits to be circularly shifted among the bits of the address ADDR_NO with the natural order based on the number of the duplication symbols included in the reception signal.

In some embodiments, the bit circular shift circuit 2413 may determine the number of the bits to be circularly shifted among the bits of the address ADDR_NO with the natural order according to Equation 5.

$$d = {log}_{2} D \qquad ( Equation 5 )$$

In Equation 5, D may be the number of the duplication symbols. The d may be the number of the bits to be circularly shifted. The number of the duplication symbols may refer to the number of the same symbols among the reception symbols. For example, referring to FIG. 4, the 0th to 15th reception symbols Y(0)-Y(15) may have two identical symbols, so that the number of the duplication symbols is “2” symbols. If the number of the duplication symbols is “2” symbols, the number of the bits to be circularly shifted may be “1” bit according to Equation 5. If the number of the bits to be circularly shifted is “1” bit, the 0th bit (b₀) among the 0th to (n-1)th bits (b₀-bₙ₋₁) may be circularly shifted to the right.

In some embodiments, the number of the duplication symbols may be determined according to a mode of the reception signal and a bandwidth of the reception signal, as shown in Table 2.

TABLE 2

| | Bandwidth | | |
|---|---|---|---|
| MODE | (MHz) | Order | Bits of Address |
| non-HT DUP | 40 | CSO_{7, 1} | b₀b₆b₅b₄b₃b₂b₁ |
| MODE | 80 | CSO_{8, 2} | b₁b₀b₇b₆b₅b₄b₃b₂ |
| | 160 | CSO_{9, 3} | b₂b₁b₀b₈b₇b₆b₅b₄b₃ |
| | 320 | CSO_{10, 4} | b₃b₂b₁b₀b₉b₈b₇b₆b₅b₄ |
| EHT DUP | 80 | CSO_{10, 1} | b₀b₉b₈b₇b₆b₅b₄b₃b₂b₁ |
| MODE | 160 | CSO_{11, 1} | b₀b₁₀b₉b₈b₇b₆b₅b₄b₃b₂b₁ |
| | 320 | CSO_{12, 1} | b₀b₁₁b₁₀b₉b₈b₇b₆b₅b₄b₃b₂b₁ |

In some embodiments, the channel of the non-HT DUP MODE with 40 MHz may include a 0th subchannel with 20 MHz and a 1st subchannel with 20 MHz. Reception symbols included in the 0th subchannel and reception symbols included in the 1st subchannel may be the same duplication symbols. Because the 0th subchannel and the 1st subchannel include the same duplication symbols, the number of the duplication symbols may be “2” if the reception signal corresponds to the non-HT DUP MODE with 40 MHz. If the number of the duplication symbols is “2” symbols, the number of bits to be circularly shifted among the bits of the address may be “1” bit. The bit circular shift circuit 2413 may circularly shift the 0th bit (b₀) among the 0th to 6th bits (b₀-b₆) of the address if the reception signal corresponds to the non-HT DUP MODE with 40 MHz.

In some embodiments, if the reception signal corresponds to the non-HT DUP MODE with 80 MHZ, each of 0th to 3rd subchannels with 20 MHz may include duplication symbols. If the reception signal corresponds to the non-HT DUP MODE with 80 MHz, the number of the duplication symbols may be “4” symbols. If the number of the duplication symbols is “4” symbols, the number of bits to be circularly shifted among the bits of the address may be “2” bits. The bit circular shift circuit 2413 may circularly shift the 0th bit (b₀) and the 1st bit (b₁) among the 0th to 7th bits (b₀-b₇) of the address if the reception signal corresponds to the non-HT DUP MODE with 80 MHZ.

In some embodiments, if the reception signal corresponds to the non-HT DUP MODE with 160 MHz, each of 0th to 7th subchannels with 20 MHz may include duplication symbols. If the reception signal corresponds to the non-HT DUP MODE with 160 MHz, the number of the duplication symbols may be “8”. If the number of the duplication symbols is “8” symbols, the number of bits to be circularly shifted among the bits of the address may be “3” bits. The bit circular shift circuit 2413 may circularly shift the 0th to 2nd bits (b₀-b₂) among the 0th to 8th bits (b₀-b₈) of the address if the reception signal corresponds to the non-HT DUP MODE with 160 MHz.

In some embodiments, if the reception signal corresponds to the non-HT DUP MODE with 320 MHz, each of 0th to 15th subchannels with 20 MHz may include duplication symbols. If the reception signal corresponds to the non-HT DUP MODE with 320 MHz, the number of the duplication symbols may be “16” symbols. If the number of the duplication symbols is “16”, the number of bits to be circularly shifted among the bits of the address may be “4” bits. The bit circular shift circuit 2413 may circularly shift the 0th to 3rd bits (b₀-b₃) of the 0th to 10th bits (b₀-b₁₀) of the address if the reception signal corresponds to the non-HT DUP MODE with 320 MHz.

In some embodiments, if the reception signal corresponds to the EHT DUP MODE with 80 MHz, the EHT DUP MODE with 160 MHz, or the EHT DUP MODE with 320 MHz, each of the 0th and 1st subchannels with 40 MHz, 80 MHz, or 160 MHz may include duplication symbols. If the reception signal corresponds to the EHT DUP MODE with 80 MHz, 160 MHz, or 320 MHz, the number of the duplication symbols may be “2”. If the number of the duplication symbols is “2” symbols, the number of bits to be circularly shifted among the bits of the address may be “1” bit. The bit circular shift circuit 2413 may circularly shift the 0th bit (b₀) among the bits of the address if the reception signal corresponds to the EHT DUP MODE with 80 MHz, 160 MHz, or 320 MHz.

In some embodiments, the bit circular shift circuit 2413 may determine the number of bits to be circularly shifted among the bits of the address based on a type of the reception signal, as shown in Table 3.

TABLE 3

| | 80 MHz EHT | 160 MHz EHT | 320 MHz EHT |
|---|---|---|---|
| TYPE | DUP MODE | DUP MODE | DUP MODE |
| L-LTF | NO₈ (CSO_{8, 0}) | NO₉ (CSO_{9, 0}) | NO₁₀ (CSO_{10, 0}) |
| L-SIG | CSO_{8, 2} | CSO_{9, 3} | CSO_{10, 4} |
| RL-SIG | CSO_{8, 2} | CSO_{9, 3} | CSO_{10, 4} |
| U-SIG | CSO_{8, 2} | CSO_{9, 3} | CSO_{10, 4} |
| EHT-SIG | CSO_{8, 2} | CSO_{9, 3} | CSO_{10, 4} |
| EHT-LTF | NO₁₀ (CSO_{10, 0)} | NO₁₁ (CSO_{11, 0}) | NO₁₂ (CSO_{12, 0}) |
| EHT- | CSO_{10, 1} | CSO_{11, 1} | CSO_{12, 1} |
| DATA | | | |

In some embodiments, a Wi-Fi packet may include a preamble field and a data field. The preamble field may include a Legacy-Long Training Field (L-LTF), a Legacy-Signal Field (L-SIG), a Repeated Legacy-Signal Field (RL-SIG), a Universal-Signal Field (U-SIG), and an Extremely High Throughput-Signal Field (EHT-SIG). The data field may include an Extremely High Throughput-Long Training Field (EHT-LTF) and Extremely High Throughput-DATA (EHT-DATA).

In some embodiments, the bit circular shift circuit 2413 may not circularly shift the bits of the address if the reception signal corresponds to the L-LTF or the EHT-LTF. In Equation 4, the bits of the address with the circular shift order where d is 0 may be the same as the bits of the address with the natural order.

In some embodiments, the bit circular shift circuit 2413 may circularly shift the 0th bit (b₀) and the 1st bit (b₁) among the 0th to 7th bits (b₀-b₇) of the address if the reception signal corresponds to the L-SIG, the RL-SIG, the U-SIG, or the EHT-SIG of the EHT DUP MODE with 80 MHz.

In some embodiments, the bit circular shift circuit 2413 may circularly shift the 0th to 2nd bits (b₀-b₂) among the 0th to 8th bits (b₀-b₈) of the address if the reception signal corresponds to the L-SIG, the RL-SIG, the U-SIG, or the EHT-SIG of the EHT DUP MODE with 160 MHz.

In some embodiments, the bit circular shift circuit 2413 may circularly shift the 0th to 3rd bits (b₀-b₃) among the 0th to 9th bits (b₀-b₉) of the address if the reception signal corresponds to the L-SIG, the RL-SIG, the U-SIG, or the EHT-SIG of the EHT DUP MODE with 320 MHz.

In some embodiments, when the reception signal corresponds to the EHT-DATA, the number of bits to be circularly shifted among the bits of the address may be the same as that described in the EHT DUP MODE of Table 2.

In some embodiments, the FFT buffer controller 2400 may read the reception symbols with the natural order stored in the FFT reorder buffer memory 2300 according to the circular shift order based on the address ADDR_CSO with the circular shift order. In some embodiments, the FFT buffer controller 2400 may obtain a reception signal Y_CSO with the circular shift order including the reception symbols with the circular shift order in which the reception symbols with the natural order are reordered in the circular shift order based on the address ADDR_CSO with the circular shift order.

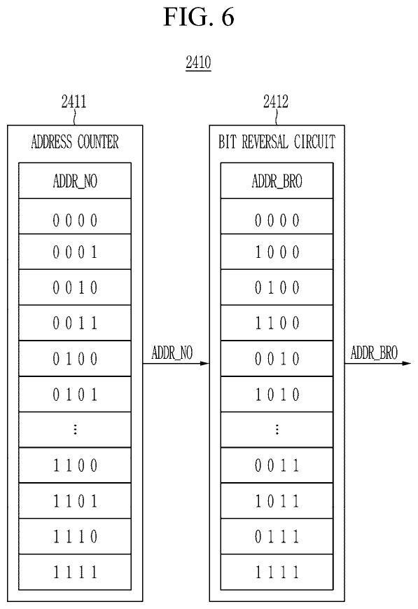

FIG. 6 illustrates the bit reversal circuit that generates the address with the bit-reversed order according to some embodiments.

In FIG. 6, a case where the reception signal includes 16 reception symbols will be described as an example. If the reception signal includes 16 reception symbols, the FFT size may be “16” symbols and the number of the bits of the address may be “4” bits.

Referring to FIGS. 4 to 6, the address counter 2411 may sequentially generate the address ADDR_NO with the natural order including four bits. In some embodiments, the address counter 2411 may sequentially generate “0000” to “1111” representing the address ADDR_NO with the natural order, and may provide “0000” to “1111” to the bit reversal circuit 2412. The bit reversal circuit 2412 may generate addresses ADDR_BRO with the bit-reversed order in which bits of addresses ADDR_NO with the natural order are reversely arranged.

In some embodiments, a result of reversely arranging the address (0000) with the natural order may be the same as “0000”. The bit reversal circuit 2412 may provide the address of “0000” to the FFT reorder buffer memory 2300. The FFT reorder buffer memory 2300 may store the 0th reception symbol Y(0) received in a 0th order from the FFT processor 2200 at a position corresponding to the address of “0000” in response to the address of “0000”.

In some embodiments, the bit reversal circuit 2412 may generate the address of “1000” in which the address of “0001” with the natural order are reversely arranged, and may provide the address of “1000” to the FFT reorder buffer memory 2300. The FFT reorder buffer memory 2300 may store the 8th reception symbol Y(8) firstly received from the FFT processor 2200 at a position corresponding to the address of “1000” in response to the address of “1000”.

The reception symbols with the bit-reversed order output from the FFT processor 2200 may be stored in the FFT reorder buffer memory 2300 with the natural order according to the address ADDR_BRO with the bit-reversed order. The FFT reorder buffer memory 2300 may store the 0th to 15th reception symbols Y(0)-Y(15) according to the natural order.

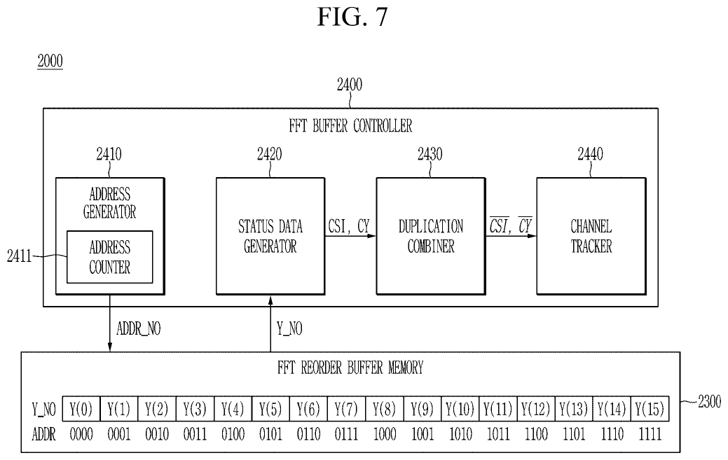

FIG. 7 is the FFT buffer controller that generates status data based on the reception signal with the natural order according to some embodiments.

Referring to FIG. 7, the address counter 2411 may generate the address ADDR_NO with the natural order, and may provide the address ADDR_NO with the natural order to the FFT reorder buffer memory 2300. The FFT reorder buffer memory 2300 may provide the reception signal Y_NO with the natural order including the reception symbols with the natural order to the status data generator 2420 in response to the address ADDR_NO with the natural order.

Each of the reception symbols included in the reception signal Y_NO with the natural order may be expressed as Equation 6.

$$Y ( k ) = X ( k ) H ( k ) + W ( k ) \qquad ( Equation 6 )$$

In Equation 6, X(k) may be a transmission symbol of a kth subcarrier. In some embodiments, referring to FIG. 2, the 1st transmission symbol (X(1)) may be a transmission symbol of a 1st subcarrier. W(k) may be an additive white Gaussian noise (AWGN) of the kth subcarrier. H(k) may be a channel response value of the kth subcarrier. Y(k) may be a reception symbol of the kth subcarrier. In some embodiments, the 1st reception symbol Y(1) may be a reception symbol of the 1st subcarrier.

The kth transmission symbol X(k) transmitted by the transmitter 1000 may be distorted into the kth reception symbol Y(k) according to the additive white Gaussian noise (W(k)) and the channel response value (H(k)).

In some embodiments, the status data generator 2420 may generate status data corresponding to each reception symbol based on the channel response value (H(k)) and the reception symbols. The status data may include channel status data CSI and compensation signal status data CY.

The channel status data CSI may be expressed as Equation 7.

$$CSI ( k ) = {\vert H ( k ) \vert}^{2} \qquad ( Equation 7 )$$

In Equation 7, CSI(k) may be channel status data of the kth subcarrier. CSI(k) may be the channel status data corresponding to the reception symbol Y(k) of the kth subcarrier. CSI(k) may be a value obtained by squaring the channel response value (H(k)) of the kth subcarrier.

The compensation signal status data CY may be expressed as Equation 8.

$$CY ( k ) = \frac{Y ( k )}{H ( k )} \cdot {\vert H ( k ) \vert}^{2} = Y ( k ) \cdot {H}^{*} ( k ) \qquad ( Equation 8 )$$

In Equation 8, CY(k) may be compensation signal status data of the kth subcarrier. CY(k) may be the compensation signal status data corresponding to the reception symbol Y(k) of the kth subcarrier. CY(k) may be a value obtained by multiplying a value obtained by dividing the reception symbol Y(k) of the kth subcarrier by the channel response value (H(k)) of the kth subcarrier by the channel status data (CSI(k)) of the kth subcarrier. CY(k) may be a value obtained by multiplying the reception symbol Y(k) of the kth sub carrier by H*(k). H*(k) may be a value obtained by dividing the channel status data (CSI(k)) of the kth subcarrier by the channel response value (H(k)) of the kth subcarrier. The channel status data (CSI(k)) may be a value obtained by squaring the channel response value (H(k)) of the kth subcarrier.

In some embodiments, the status data generator 2420 may generate the channel status data CSI and the compensation signal status data CY corresponding to the reception symbols included in the reception signal Y_NO with the natural order according to Equation 7 and Equation 8. The status data generator 2420 may provide the channel status data CSI and the compensation signal status data CY to the duplication combiner 2430.

In some embodiments, the duplication combiner 2430 may combine the channel status data corresponding to the duplication symbols among the reception symbols included in the reception signal Y_NO with the natural order and the compensation signal status data corresponding to the duplication symbols. The duplication combiner 2430 may provide the combined channel status data C̅S̅I̅ and the combined compensation signal status data C̅Y̅ to the channel tracker 2440.

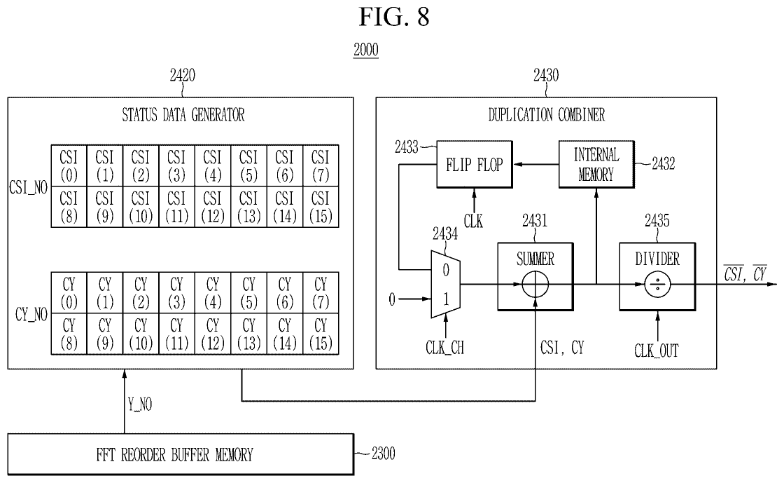

FIG. 8 is the duplication combiner that combines status data with the natural order according to some embodiments.

Referring to FIG. 8, the status data generator 2420 may receive the reception signal Y_NO with the natural order including the reception symbols with the natural order, and may generate the channel status data CSI and the compensation signal status data CY corresponding to the reception symbols with the natural order, respectively.

In some embodiments, the status data generator 2420 may generate channel status data CSI_NO with the natural order. In some embodiments, the status data generator 2420 may sequentially generate 0th to 15th channel status data CSI(0)-CSI(15) respectively corresponding to the 0th to 15th reception symbols Y(0)-Y(15).

In some embodiments, the status data generator 2420 may generate compensation signal status data CY_NO with the natural order. In some embodiments, the status data generator 2420 may sequentially generate 0th to 15th compensation signal status data CY(0)-CY(15) respectively corresponding to the 0th to 15th reception symbols Y(0)-Y(15).

In some embodiments, the status data generator 2420 may provide the channel status data CSI_NO with the natural order or the compensation signal status data CY_NO with the natural order to the duplication combiner 2430.

In some embodiments, the duplication combiner 2430 may combine the channel status data corresponding to the duplication symbols, and may combine the compensation signal status data corresponding to the duplication symbols. The duplication combiner 2430 may output the combined channel status data C̅S̅I̅ and the combined compensation signal status data C̅Y̅.

The combined channel status data C̅S̅I̅ may be expressed as Equation 9.

$$\overline{CSI} ( k ) = \frac{1}{D} \cdot {\sum }_{d = 0}^{D - 1} CSI ( ( k \% \frac{N}{D} ) + d \cdot \frac{N}{d} ) \qquad ( Equation 9 )$$

In Equation 9, C̅S̅I̅(k) may be the combined channel status data of the kth subcarrier. C̅S̅I̅(k) may be the combined channel status data corresponding to the reception symbol Y(k) of the kth subcarrier. D may be the number of the duplication symbols. N may be the FFT size.

In some embodiments, if the FFT size is “16” and the number of the duplication symbols is “2”, the combined 0th channel status data C̅S̅I̅(0) of the 0th subcarrier may be a value obtained by dividing a sum of the 0th channel status data C̅S̅I̅(0) and the 8th channel status data CSI(8) according to Equation 9 by the number of the duplication symbols that is “2”.

The combined compensation signal status data C̅Y̅ may be expressed as Equation 10.

$$\overline{CY} ( k ) = \frac{1}{D} \cdot {\sum }_{d = 0}^{D - 1} CY ( ( k \% \frac{N}{D} ) + d \cdot \frac{N}{D} ) \qquad ( Equation 10 )$$

In Equation 10, C̅Y̅(k) may be the combined compensation signal status data of the kth subcarrier. C̅Y̅(k) may be the combined compensation signal status data corresponding to the reception symbol Y(k) of the kth subcarrier. D may be the number of the duplication symbols. N may be the FFT size.

In some embodiments, if the FFT size is “16” and the number of the duplication symbols is “2”, the combined 1st channel status data C̅S̅I̅(1) of the 1st subcarrier may be a value obtained by dividing a sum of the 1st channel status data CSI(1) and the 9th channel status data CSI(9) according to Equation 9 by the number of the duplication symbols that is “2”.

In some embodiments, the duplication combiner 2430 may include a summer 2431, an internal memory 2432, a flip-flop 2433, a multiplexer 2434, and a divider 2435.

In some embodiments, the summer 2431 may combine the channel status data corresponding to the duplication symbols among the channel status data. In some embodiments, the summer 2431 may combine the channel status data corresponding to the duplication symbols among the 0th to 15th channel status data CSI(0)-CSI(15).

In some embodiments, because the 0th reception symbol Y(0) and the 8th reception symbol Y(8) are the duplication symbols, the summer 2431 may combine the 0th channel status data CSI(0) and the 8th channel status data CSI(8) corresponding to the 0th reception symbol Y(0) and the 8th reception symbol Y(8). In some embodiments, because the 1st reception symbol Y(1) and the 9th reception symbol Y(9) are the duplication symbols, the summer 2431 may combine the 1st channel status data CSI(1) and the 9th channel status data CSI(9) corresponding to the 1th reception symbol Y(1) and the 9th reception symbol Y(9).

In some embodiments, the internal memory 2432 may store the channel status data CSI or the compensation signal status data CY received from the status data generator 2420. In some embodiments, the internal memory 2432 may store the 0th to 15th channel status data CSI(0)-CSI(15) or the 0th to 15th compensation signal status data CY(0)-CY(15).

In some embodiments, the flip-flop 2433 may receive the channel status data CSI or the compensation signal status data CY from the internal memory 2432, and may provide the channel status data CSI or the compensation signal status data CY to the multiplexer 2434 in response to a clock signal CLK.

In some embodiments, the multiplexer 2434 may select data to be combined with the channel status data CSI or the compensation signal status data CY received from the status data generator 2420. In some embodiments, the multiplexer 2434 may select zero data in response to a channel clock signal CLK_CH, or may select the channel status data CSI or the compensation signal status data CY. In some embodiments, the multiplexer 2434 may select the zero data in response to the channel clock signal CLK_CH with a high level. In some embodiments, the multiplexer 2434 may select the channel status data CSI or the compensation signal status data CY received from the flip-flop 2433 in response to the channel clock signal CLK_CH with a low level.

In some embodiments, the divider 2435 may divide the combined status data or the combined compensation signal status data received from the summer 2431 by the number of the duplication symbols. In some embodiments, the divider 2435 may divide data obtained by combining the 0th channel status data CSI(0) and the 8th channel status data CSI(8) by “2”, which is the number of the duplication symbols.

In some embodiments, the divider 2435 may output the combined channel status data C̅S̅I̅ or the combined compensation signal status data C̅Y̅ in response to an output clock signal CLK_OUT.

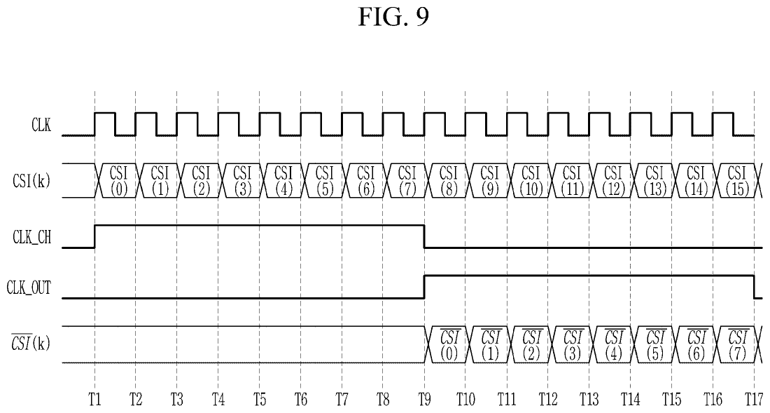

FIG. 9 is a timing diagram for describing an operation of the duplication combiner according to some embodiments.

In FIGS. 9 to 11, the duplication combiner 2430 combining the channel status data CSI will be described as an example. In FIGS. 9 to 11, the above description may be equally applied to a case where the compensation signal status data CY are combined.

Referring to FIG. 9, the duplication combiner 2430 may receive the channel status data CSI_NO with the natural order. In some embodiments, the duplication combiner 2430 may sequentially receive the 0th to 15th channel status data CSI(0)-CSI(15).

In some embodiments, in a section from T1 to T9, the duplication combiner 2430 may sequentially receive the 0th to 7th channel status data CSI(0)-CSI(7). Because each of the 0th to 7th channel status data CSI(0)-CSI(7) is not the channel status data corresponding to the duplication symbols, the multiplexer 2434 may select the zero data in response to the channel clock signal CLK_CH with the high level if the 0th to 7th channel status data CSI(0)-CSI(7) are received. The 0th to 7th channel status data CSI(0)-CSI(7) may be stored in the internal memory 2432.

In some embodiments, in a section from T9 to T10, the summer 2431 may receive the 8th channel status data CSI(8). The internal memory 2432 may provide the 0th channel status data CSI(0) to the multiplexer 2434 through the flip-flop 2433.

In the section from T9 to T10, the multiplexer 2434 may select the 0th channel status data CSI(0) in response to the channel clock signal CLK_CH with the low level, and may provide the 0th channel status data CSI(0) to the summer 2431. In the section from T9 to T10, the summer 2431 may combine the 0th channel status data CSI(0) and the 8th channel status data CSI(8). In the section from T9 to T10, the summer 2431 may provide data combining the 0th channel status data CSI(0) and the 8th channel status data CSI(8) to the divider 2435.

In the section from T9 to T10, the divider 2435 may generate the combined 0th channel status data C̅S̅I̅(0) corresponding to a result of dividing the data obtained by combining the 0th channel status data CSI(0) and the 8th channel status data CSI(8) by the number of the duplication symbols. In the section from T9 to T10, the divider 2435 may output the combined 0th channel status data C̅S̅I̅(0) in response to the output clock signal CLK_OUT with a high level.

In some embodiments, in a section from T10 to T17, the duplication combiner 2430 may sequentially receive the 9th to 15th channel status data CSI(9)-CSI(15), and may sequentially combine the 9th to 15th channel status data CSI(9)-CSI(15) with the 1st to 7th channel status data CSI(1)-CSI(7) stored in the internal memory 2432. In the section from T10 to T17, the duplication combiner 2430 may output the combined 1st to 7th channel status data C̅S̅I̅(1)-C̅S̅I̅(7).

If the channel status data CSI_NO with the natural order is received, the duplication combiner 2430 may need to store some channel status data in the internal memory 2432 until channel status data to be combined is received. If the channel status data CSI_NO with the natural order is received, a time point at which the channel status data corresponding to the duplication symbols are combined may be delayed.

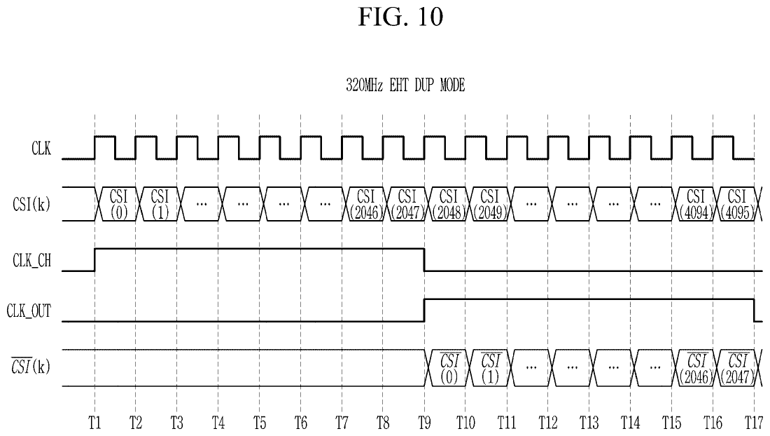

FIG. 10 is a timing diagram for describing the duplication combiner that combines the status data with the natural order in the EHT DUP MODE with 320 MHZ according to some embodiments.

Referring to FIG. 10, if the reception signal corresponds to the EHT DUP MODE with 320 MHZ, the FFT size may be “4096” according to Table 1, and the reception signal may include 0th to 4095th reception symbols. If the reception signal corresponds to the EHT DUP MODE with 320 MHz, as described in Table 2, each of 1st and 2nd subchannels with 160 MHz may include duplication symbols so that the number of the duplication symbols is “2”. In some embodiments, the 0th reception symbol and the 2048th reception symbol may be the duplication symbols.

In some embodiments, the status data generator 2420 may generate 0th to 4095th channel status data CSI(0)-CSI(4095) corresponding to the 0th to 4095th reception symbols according to the natural order.

In some embodiments, in a section from T1 to T9, the duplication combiner 2430 may sequentially receive the 0th to 2047th channel status data CSI(0)-CSI(2047). The 0th to 2047th channel status data CSI(0)-CSI(2047) may be stored in the internal memory 2432 until the 2048th to 4095th status data CSI(2048)-CSI(4095) are received from the status data generator 2420.

In some embodiments, in a section from T9 to T17, the duplication combiner 2430 may sequentially receive the 2048th to 4095th status data CSI(2048)-CSI(4095), and may sequentially combine the 2048th to 4095th status data CSI(2048)-CSI(4095) with the 0th to 2047th channel status data CSI(0)-CSI(2047) stored in the internal memory 2432. In the section from T9 to T17, the duplication combiner 2430 may sequentially output the combined 0th to 2047th channel status data C̅S̅I̅(0)-C̅S̅I̅(2047).

In some embodiments, if the channel status data CSI_NO with the natural order is combined, a time point in which the channel status data are combined may be delayed as the number of the channel status data increases.

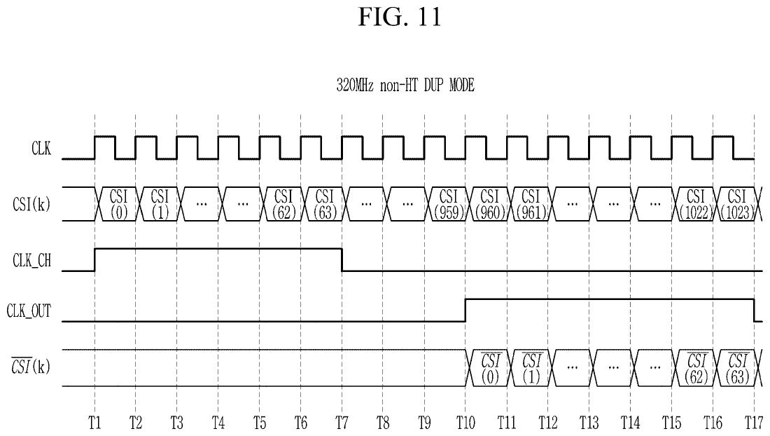

FIG. 11 is a timing diagram for describing the duplication combiner that combines the status data with the natural order in the non-HT DUP MODE with 320 MHz according to some embodiments.

Referring to FIG. 11, if the reception signal corresponds to the non-HT DUP MODE with 320 MHz, the FFT size is “1024” according to Table 1, and the reception signal may include 0th to 1023th reception symbols. If the reception signal corresponds to the non-HT DUP MODE with 320 MHZ, as described in Table 2, each of 1st to 16th subchannels with 20 MHz may include duplication symbols so that the number of the duplication symbols is “16”. In some embodiments, the 0th reception symbol, the 64th reception symbol, the 128th reception symbol, the 192th reception symbol, the 256th reception symbol, the 320th reception symbol, the 384th reception symbol, the 448th reception symbol, the 512th reception symbol, the 576th reception symbol, the 640th reception symbol, the 704th reception symbol, the 768th reception symbol, the 832th reception symbol, the 896th reception symbol, and the 960th reception symbol may be the duplication symbols.

In some embodiments, the status data generator 2420 may generate 0th to 1023th channel status data CSI(0)-CSI(1023) corresponding to the 0th to 1023th reception symbols according to the natural order.

In some embodiments, in a section from T1 to T10, the duplication combiner 2430 may sequentially receive the 0th to 959th channel status data CSI(0)-CSI(959). The 0th to 959th channel status data CSI(0)-CSI(959) may be stored in the internal memory 2432 until the 960th to 1023th status data CSI(960)-CSI(1023) are received from the status data generator 2420.

In some embodiments, in a section from T10 to T17, the duplication combiner 2430 may sequentially receive the 960th to 1023th status data CSI(960)-CSI(1023), and may sequentially combine the 960th to 1023th status data CSI(960)-CSI(1023) with the 0th to 959th channel status data CSI(0)-CSI(959) stored in the internal memory 2432. In the section from T10 to T17, the duplication combiner 2430 may sequentially output the combined 0th to 63th channel status data C̅S̅I̅(0)-C̅S̅I̅(63).

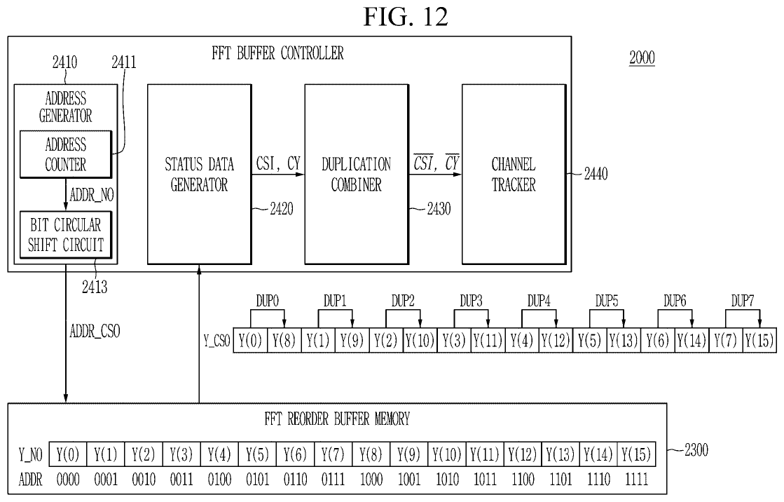

FIG. 12 is the FFT buffer controller that reorders the reception signal with the natural order into the reception signal with the circular shift order based on the address with the circular shift order according to some embodiments.

Referring to FIG. 12, the address counter 2411 may provide the address ADDR_NO with the natural order to the bit circular shift circuit 2413. The bit circular shift circuit 2413 may generate the address ADDR_CSO with the circular shift order circularly shifting at least one bit among the bits of the address ADDR_NO with the natural order. The bit circular shift circuit 2413 may provide the address ADDR_CSO with the circular shift order to the FFT reorder buffer memory 2300.

The FFT reorder buffer memory 2300 may store reception symbols with the natural order. The FFT reorder buffer memory 2300 may provide the FFT buffer controller 2400 with the reception signal Y_CSO with the circular shift order including reception symbols with the circular shift order in which the reception symbols with the natural order are reordered according to the circular shift order in response to the address ADDR_CSO with the circular shift order.

0th to 15th reception symbols Y(0)-Y(15) with the natural order stored in the FFT reorder buffer memory 2300 may be provided to the FFT buffer controller 2400 in an order of the 0th reception symbol Y(0), the 8th reception symbol Y(8), the 1st reception symbol Y(1), the 9th reception symbol Y(9), the 2nd reception symbol Y(2), the 10th reception symbol Y(10), the 3rd reception symbol Y(3), the 11th reception symbol Y(11), the 4th reception symbol Y(4), the 12th reception symbol Y(12), the 5th reception symbol Y(5), the 13th reception symbol Y(13), the 6th reception symbol Y(6), the 14th reception symbol Y(14), the 7th reception symbol Y(7), and the 15th reception symbol Y(15).

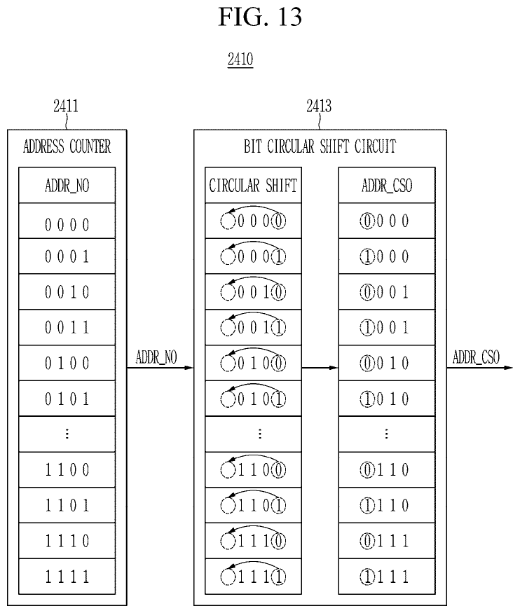

FIG. 13 illustrates the bit circular shift circuit that generates the address with the circular shift order according to some embodiments.

In FIG. 13, a case in which the reception signal includes 16 reception symbols will be described as an example. If the reception signal includes 16 reception symbols, the FFT size may be “16” and the number of the bits of the address may be “4”. The 0th to 15th receiving symbols Y(0)-Y(15) may have two duplication symbols that are identical to each other.

Referring to FIG. 12 and FIG. 13, the address counter 2411 may sequentially generate “0000” to “111111” indicating the addresses ADDR_NO with the natural order, and may provide the generated addresses to the bit circular shift circuit 2413.

In some embodiments, because the number of the duplication symbols is “2, the bit circular shift circuit 2413 may determine the number of bits to be circularly shifted among the bits of the address of the FFT reorder buffer memory 2300 as “1” according to Equation 5. The bit circular shift circuit 2413 may circularly shift a 0th bit (b₀) among 0th to 3rd bits (b₀-b₃) of the address ADDR_NO with the natural order.

In some embodiments, a result of circularly shifting “0” corresponding to the 0th bit (b₀) among the address of “0000” with the natural order may be the same as “0000”. The bit circular shift circuit 2413 may provide the address of “0000” to the FFT reorder buffer memory 2300. The FFT reorder buffer memory 2300 may provide the FFT buffer controller 2400 with the 0th reception symbol Y(0) stored in the address of “0000” in response to the address of “0000”.

The bit circular shift circuit 2413 may generate an address of “1000” obtained by circularly shifting “1” corresponding to the 0th bit (b₀) among the address of “0001” with the natural order, and may provide the address of “1000” to the FFT reorder buffer memory 2300. The FFT reorder buffer memory 2300 may provide the 8th reception symbol Y(8) stored in the address of “1000” to the FFT buffer controller 2400 in response to the address of “1000”.

The bit circular shift circuit 2413 may generate an address of “0001” obtained by circularly shifting “0” corresponding to the 0th bit (b₀) among the address of “0010” with the natural order, and may provide the address of “0001” to the FFT reorder buffer memory 2300. The FFT reorder buffer memory 2300 may provide the 1st reception symbol Y(1) stored in the address of “0001” to the FFT buffer controller 2400 in response to the address of “0001”.

The bit circular shift circuit 2413 may generate an address of “1001” obtained by circularly shifting “1” corresponding to the 0th bit (b₀) among the address of “0011” with the natural order, and may provide the address of “1001” to the FFT reorder buffer memory 2300. The FFT reorder buffer memory 2300 may provide the 9th reception symbol Y(9) stored in the address of “1001” to the FFT buffer controller 2400 in response to the address of “1001”.

The reception symbols with the natural order stored in the FFT reorder buffer memory 2300 may be read in the circular shift order according to the address ADDR_CSO with the circular shift order.

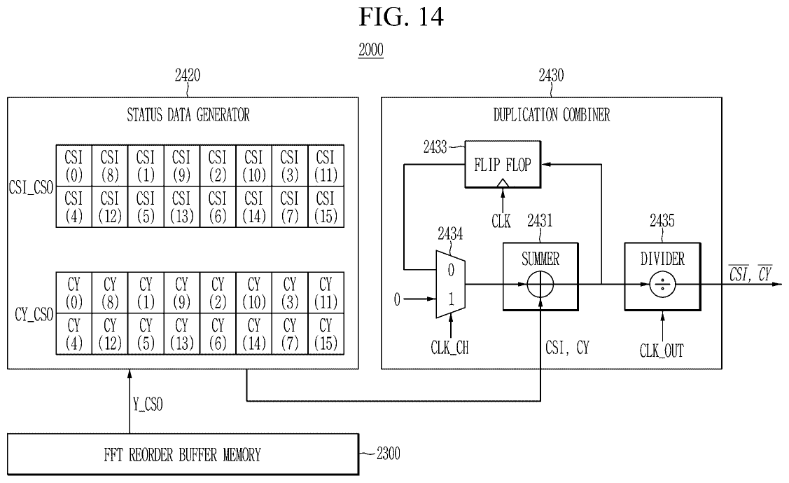

FIG. 14 illustrates the duplication combiner that combines status data with the circular shift order according to some embodiments.

Referring to FIG. 14, the status data generator 2420 may receive the reception signal Y_CSO with the circular shift order including reception symbols with the circular shift order from the FFT reorder buffer memory 2300.

In some embodiments, the status data generator 2420 may generate channel status data CSI_CSO with the circular shift order and compensation signal status data CY_CSO with the circular shift order based on the reception symbols with the circular shift order and the channel response value.

A duplication combiner 2430 may receive the channel status data CSI_CSO with the circular shift order or the compensation signal status data CY_CSO with the circular shift order. In some embodiments, the duplication combiner 2430 may continuously receive the 0th channel status data CSI(0) and the 8th channel status data CSI(8) corresponding to the duplication symbols. Unlike the duplication combiner 2430 of FIG. 8, the duplication combiner 2430 of FIG. 14 may continuously receive the 8th channel status data CSI(8) to be combined with the 0th channel status data CSI(0), so that the internal memory 2432 to be stored in the 0th channel status data CSI(0) may not be necessary until the 8th channel status data CSI(8) is received. In some embodiments, the duplication combiner 2430 of FIG. 14 may not include the internal memory 2432.

In some embodiments, if the channel status data CSI_CSO with the circular shift order or the compensation signal status data CY_CSO with the circular shift order are received, the duplication combiner 2430 may continuously combine the channel status data or the compensation signal status data corresponding to the duplication symbols.

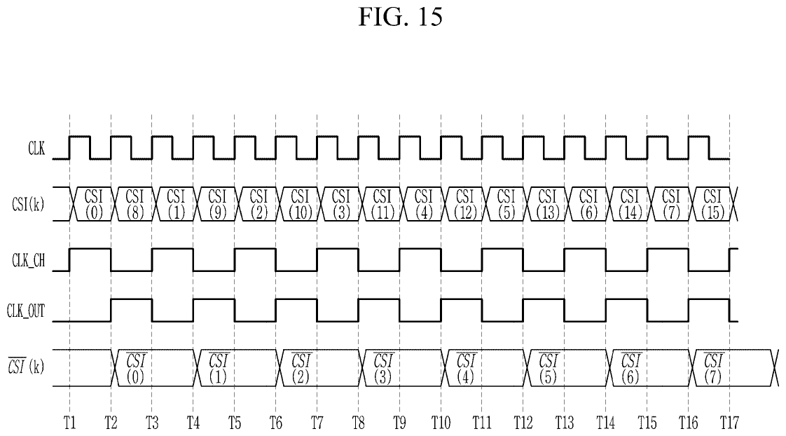

FIG. 15 is a timing diagram for describing the duplication combiner that combines the status data with the circular shift order according to some embodiments.

In FIGS. 15 to 17, the duplication combiner 2430 combining the channel status data CSI will be described as an example. In FIGS. 15 to 17, the above description may be equally applied to a case where the compensation signal status data CY are combined.

Referring to FIG. 15, the duplication combiner 2430 of FIG. 14 may receive the channel status data CSI_CSO with the circular shift order. In some embodiments, the duplication combiner 2430 of FIG. 14 may sequentially receive 0th to 15th channel status data CSI(0)-CSI(15).

In some embodiments, in a section from T1 to T2, the summer 2431 may receive the 0th channel status data CSI(0) from the status data generator 2420, and may store the 0th channel status data CSI(0) in the flip-flop 2433.

In a section from T2 to T3, the multiplexer 2434 may receive the 0th channel status data CSI(0) from the flip-flop 2433, and may select the 0th channel status data CSI(0) from the 0th channel status data CSI(0) and zero data in response to a channel clock signal CLK_CH with a low level. The multiplexer 2434 may provide the 0th channel status data CSI(0) to the summer 2431.

In the section from T2 to T3, the summer 2431 may receive the 8th channel status data CSI(8) from the status data generator 2420, and may receive the 0th channel status data CSI(0) from the multiplexer 2434. The summer 2431 may combine the 0th channel status data CSI(0) and the 8th channel status data CSI(8). The summer 2431 may provide data combining the 0th channel status data CSI(0) and the 8th channel status data CSI(8) to the divider 2435.

In the section from T2 to T3, the divider 2435 may generate the combined 0th channel status data C̅S̅I̅(0) corresponding to a result of dividing data obtained by combining the 0th channel status data CSI(0) and the 8th channel status data CSI(8) by the number of the duplication symbols. In the section from T2 to T3, the divider 2435 may output the combined 0th channel status data C̅S̅I̅(0) in response to an output clock signal CLK_OUT with a high level.

In a section from T3 to T4, the duplication combiner 2430 may receive 1st channel status data CSI(1), and in a section from T4 to T5, the duplication combiner 2430 may receive 9th channel status data CSI(9). In the section from T4 to T5, the duplication combiner 2430 may generate the combined 1st channel status data C̅S̅I̅(1) corresponding to a result of dividing data obtained by combining the 1st channel status data CSI(1) and the 9th channel status data CSI(9) by the number of the duplication symbols.

In a section from T5 to T17, the duplication combiner 2430 may receive the channel status data CSI_CSO with the circular shift order, may continuously combine the channel status data corresponding to the duplication symbols, and may output the combined channel status data C̅S̅I̅.

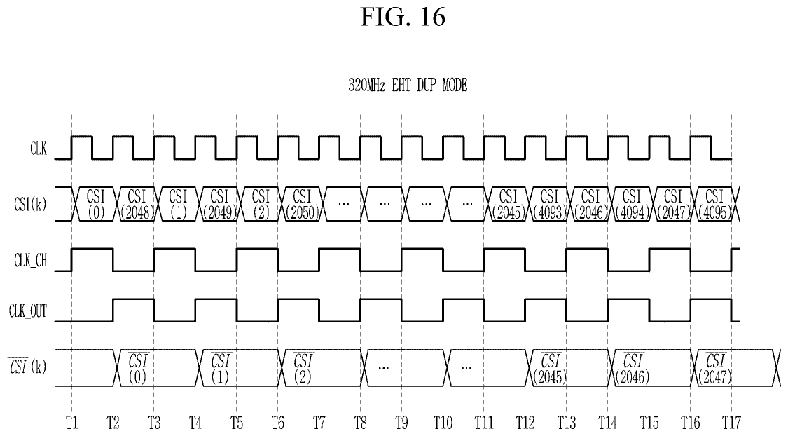

FIG. 16 is a timing diagram for describing the duplication combiner that combines the status data with the circular shift order in the EHT DUP MODE with 320 MHz according to some embodiments.

Referring to FIG. 16, if the reception signal corresponds to the EHT DUP MODE with 320 MHz, the FFT size is “4096” according to Table 1, and the reception signal may include 0th to 4095th reception symbols. If the reception signal corresponds to the EHT DUP MODE with 320 MHz, as described in Table 2, each of 1st and 2nd subchannels with 160 MHz may include duplication symbols so that the number of the duplication symbols is “2”. In some embodiments, the 0th reception symbol and the 2048th reception symbol may be the duplication symbols.

In some embodiments, the status data generator 2420 may generate 0th to 4095th channel status data CSI(0)-CSI(4095) corresponding to the 0th to 4095th reception symbols according to the circular shift order.

In some embodiments, in a section from T1 to T3, the duplication combiner 2430 may receive the 0th channel status data CSI(0) and the 2048th channel status data CSI(2048) corresponding to the duplication symbols, and may combine the 0th channel status data CSI(0) and the 2048th channel status data CSI(2048). The duplication combiner 2430 may output the combined channel 0th status data C̅S̅I̅(0).

In some embodiments, in a section from T3 to T5, the duplication combiner 2430 may receive the 1st channel status data CSI(1) and the 2049th channel status data CSI(2049) corresponding to the duplication symbols, and may combine the first channel status data CSI(1) and the 2049th channel status data CSI(2049). The duplication combiner 2430 may output the combined 1st channel status data C̅S̅I̅(1).

In some embodiments, in a section from T5 to T17, the duplication combiner 2430 may receive the channel status data CSI_CSO with the circular shift order, and may continuously combine the channel status data corresponding to the duplication symbols.

In some embodiments, a time point at which the channel status data to be combined is received of a case in which the channel status data CSI_CSO with the circular shift order are combined may be faster than a time point at which the channel status data to be combined is received of a case in which the channel status data CSI_NO with the natural order are combined.

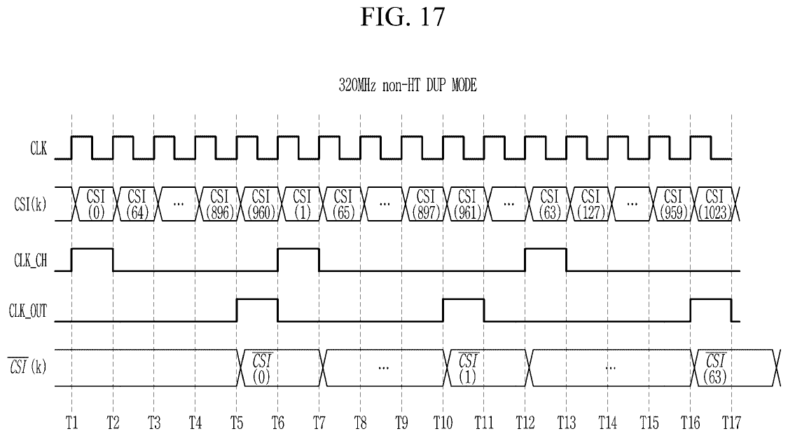

FIG. 17 is a timing diagram for describing the duplication combiner that combines the status data with the circular shift order in the non-HT DUP MODE with 320 MHz according to some embodiments.

Referring to FIG. 17, if the reception signal corresponds to the non-HT DUP MODE with 320 MHz, the FFT size is “1024” according to Table 1, and the reception signal may include 0th to 1023th reception symbols. If the reception signal corresponds to the non-HT DUP MODE with 320 MHz, as described in Table 2, each of 1st to 16th subchannels with 20 MHz may include duplication symbols so that the number of the duplication symbols is “16”. In some embodiments, the 0th reception symbol, the 64th reception symbol, the 128th reception symbol, the 192th reception symbol, the 256th reception symbol, the 320th reception symbol, the 384th reception symbol, the 448th reception symbol, the 512th reception symbol, the 576th reception symbol, the 640th reception symbol, the 704th reception symbol, the 768th reception symbol, the 832th reception symbol, the 896th reception symbol, and the 960th reception symbol may be the duplication symbols.

In some embodiments, the status data generator 2420 may generate 0th to 1023th channel status data corresponding to the 0th to 1023th reception symbols according to the circular shift order.

In some embodiments, in a section from T1 to T6, the duplication combiner 2430 may combine the 0th channel status data CSI(0), the 64th channel status data CSI(64), the 128th channel status data CSI(128), the 192nd channel status data CSI(192), the 256th channel status data CSI(256), the 320th channel status data CSI(320), the 384th channel status data CSI(384), the 448th channel status data CSI(448), the 512th channel status data CSI(512), the 576th channel status data CSI(576), the 640th channel status data CSI(640), the 704th channel status data CSI(704), the 768th channel status data CSI(768), the 832th channel status data CSI(832), the 896th channel status data CSI(896), and the 960th channel status data CSI(960) that correspond to the duplication symbols. The duplication combiner 2430 may output the combined 0th channel status data C̅S̅I̅(0).

In a section from T6 to T17, the duplication combiner 2430 may receive the channel status data CSI_CSO with the circular shift order, and may continuously combine the channel status data corresponding to the duplication symbols.

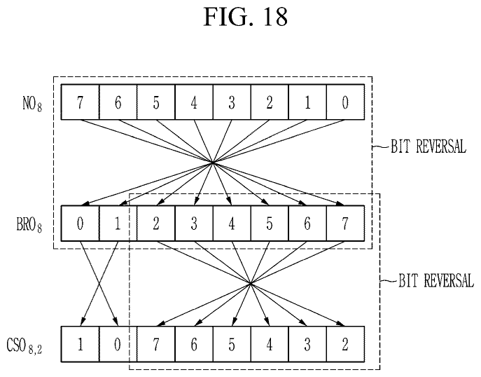

FIG. 18 is a bit inversion relationship between the natural order, the bit-reversed order, and the circular shift order according to some embodiments.

In FIG. 18, the non-HT DUP MODE with 80 MHz will be described as an example. In the non-HT DUP MODE with 80 MHz, the number of bits of an address of the FFT reorder buffer memory 2300 may be “8”.

All of 0th to 7th bits of the address NO₈ with the natural order and all of 0th to 7th bits of the address BRO₈ with the bit-reversed order may have a reverse bit relationship. The 2th to 7th bits of the address BRO₈ with the bit-reversed order and 2th to 7th bits of the address CSO_{8,2} with the circular shift order may have a reverse bit relationship.

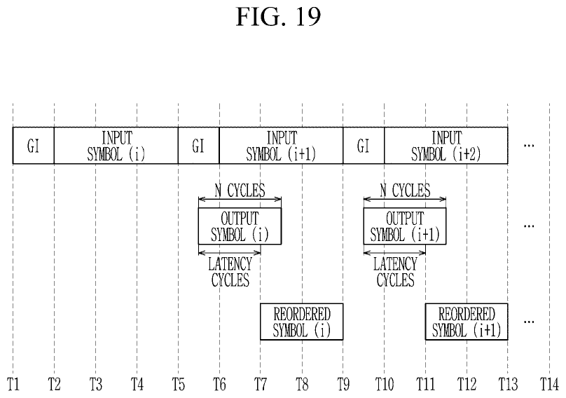

FIG. 19 is a timing diagram for describing the receiver that reorders reception symbols included in the reception signal according to some embodiments.

Referring to FIG. 19, a section from T1 to T2, a section from T5 to T6, and a section from T9 to T10 may be a guard interval GI for preventing an Inter-Symbol Interference (ISI).

In a section from T2 to T5, the FFT processor 2200 may receive ith symbols (SYMBOL (i)) with the natural order. The FFT processor 2200 may perform a fast Fourier transform operation on the ith symbols (SYMBOL (i)) with the natural order during N cycles (N CYCLES), and may output ith symbols (SYMBOL (i)) with the bit-reversed order. The FFT processor 2200 may receive (i+1) th symbols while outputting the ith symbols (SYMBOL (i)).

In some embodiments, the FFT buffer controller 2400 may control the ith symbols (SYMBOL (i)) with the bit-reversed order to be stored in the FFT reorder buffer memory 2300 according to the natural order. The FFT buffer controller 2400 may control the FFT reorder buffer memory 2300 to read the ith symbols with the natural order stored in the FFT reorder buffer memory 2300 according to the circular shift order from a time point when a delay cycle (LATENCY CYCLES) passes from a time point when the ith symbols (SYMBOL (i)) with the bit-reversed order are output. The delay cycle (LATENCY CYCLES) may be an overhead for reordering the ith symbols (SYMBOL (i)) with the bit-reversed order according to the natural order.

In some embodiments, the FFT reorder buffer memory 2300 may provide the FFT buffer controller 2400 with ith symbols (REORDERED SYMBOL (i)) reordered according to the circular shift order from a time point T7 when the delay cycle (LATENCY CYCLES) passes.

Likewise, the FFT processor 2200 may output the (i+1)th symbols (SYMBOL (i+1)) while receiving (i+2)th symbols (SYMBOL (i+2)). The FFT buffer controller 2400 may read the (i+1)th symbols (SYMBOL (i+1)) stored in the FFT reorder buffer memory 2300 according to the circular shift order from a time point when the delay cycle (LATENCY CYCLES) passes while the FFT processor 2200 receives the (i+2)th symbols (SYMBOL (i+2)).

A minimum delay cycle may be expressed as Equation 11.

$${L}_{min} = {max}_{0 \leq I < N} ( BRO ( RO ( I ) ) - I ) \qquad ( Equation 11 )$$

In Equation 11, Lₘᵢₙ may be the minimum delay cycle. I may be a clock cycle in which the FFT reorder buffer memory 2300 outputs the symbols. BRO(RO(I)) may be a clock cycle in which the FFT processor 2200 outputs the symbols with the bit-reversed order. RO(I) may be a clock cycle with an order in which the symbols with the bit-reversed order are reordered. If RO(I) corresponds to the bit-reversed order, Lₘᵢₙ may be “0”.

If RO(I) corresponds to the natural order, Lₘᵢₙ may be expressed as Equation 12.

$${L}_{min , NO} = {max}_{0 \leq I < N} ( BRO ( I ) - I ) \qquad ( Equation 12 )$$

L_{min,NO} may be a minimum delay cycle required when the symbols with the bit-reversed order output by the FFT processor 2200 are reordered in the natural order.

If the reception signal corresponds to the non-HP DUP MODE, the minimum delay cycle in which the symbols with the bit-reversed order is reordered in the natural order or the circular shift order may be expressed as Table 4.

TABLE 4

| | | |
|---|---|---|
| FFT | BRO−>NO | BRO−>CSO |

| Bandwidth | size | | Lₘᵢₙ/N | | Lₘᵢₙ/N |
|---|---|---|---|---|---|
| (MHz) | (N) | Lₘᵢₙ | (%) | Lₘᵢₙ | (%) |
| 20 | 64 | 49 | 76.6 | 49 | 76.6 |
| 40 | 128 | 105 | 82.0 | 98 | 76.6 |
| 80 | 256 | 225 | 87.9 | 197 | 77.0 |
| 160 | 512 | 465 | 90.8 | 395 | 77.1 |
| 320 | 1024 | 961 | 93.8 | 793 | 77.4 |

In Table 4, if the reception symbols with the bit-reversed order (BRO) are reordered into the reception symbols with the natural order (NO), a ratio (Lₘᵢₙ/N) of the minimum delay cycle to the FFT size (N) may increase as the FFT size increases. If the FFT size (N) increases from “64” to “1024” when the reception symbols with the bit-reversed order (BRO) are reordered into the reception symbols with the natural order (NO), the ratio (Lₘᵢₙ/N) of the minimum delay cycle to the FFT size (N) may increase by “17.2%” from “76.6%” to “93.8%”.

Even if the FFT size (N) increases, the ratio (Lₘᵢₙ/N) of the minimum delay cycle to the FFT size (N) of a case in which the reception symbols with the bit-reversed order (BRO) are reordered into the reception symbols with the circular shift order (CSO) may increase less than the ratio (Lₘᵢₙ/N) of the minimum delay cycle to the FFT size (N) of a case in which the reception symbols with the bit-reversed order (BRO) are reordered into the reception symbols with the natural order (NO). If the FFT size (N) increases from “64” to “1024”, the ratio (Lₘᵢₙ/N) of the minimum delay cycle to the FFT size (N) may only increase by “0.8%” from “76.6%” to “77.4%”. In the non-HP DUP MODE, the number of the duplication symbols to be combined may increase as the FFT size (N) increases, so that the ratio (Lₘᵢₙ/N) of the minimum delay cycle to the FFT size (N) of a case in which the duplication symbols are combined according to the circular shift order (CSO) may increase less than the ratio (Lₘᵢₙ/N) of the minimum delay cycle to the FFT size (N) of a case in which the duplication symbols are combined according to the natural order (NO).

In the non-HP DUP MODE with 320 MHz, the ratio (Lₘᵢₙ/N) of the minimum delay cycle to the FFT size (N) of a case in which the reception symbols with the bit-reversed order (BRO) are reordered into the reception symbols with the circular shift order (CSO) may be “16.4%” less than the ratio (Lₘᵢₙ/N) of the minimum delay cycle to the FFT size (N) of a case in which the reception symbols with the bit-reversed order (BRO) are reordered into the reception symbols with the natural order (NO).

If the reception signal corresponds to the EHP DUP MODE, the minimum delay cycle in which the symbols with the bit-reversed order are reordered in the natural order or the circular shift order may be expressed as Table 5.

TABLE 5

| | | |
|---|---|---|
| FFT | BRO−>NO | BRO−>CSO |

| Bandwidth | size | | Lₘᵢₙ/N | | Lₘᵢₙ/N |
|---|---|---|---|---|---|
| (MHz) | (N) | Lₘᵢₙ | (%) | Lₘᵢₙ | (%) |
| 80 | 1024 | 961 | 93.8 | 930 | 90.8 |
| 160 | 2048 | 1953 | 95.4 | 1922 | 93.8 |
| 320 | 4096 | 3969 | 96.9 | 3906 | 95.4 |

In Table 5, if the FFT size (N) increases from “1024” to “2048” when the reception symbols with the bit-reversed order (BRO) are reordered into the reception symbols with the natural order (NO), the ratio (Lₘᵢₙ/N) of the minimum delay cycle to the FFT size (N) may increase by “3.1%” from “93.8%” to “96.9%”.

If the FFT size (N) increases from “1024” to “2048” when the reception symbols with the bit-reversed order (BRO) are reordered into the reception symbols with the circular shift order (CSO), the ratio (Lₘᵢₙ/N) of the minimum delay cycle to the FFT size (N) may increase by “4.6%” from “90.8%” to “95.4%”.

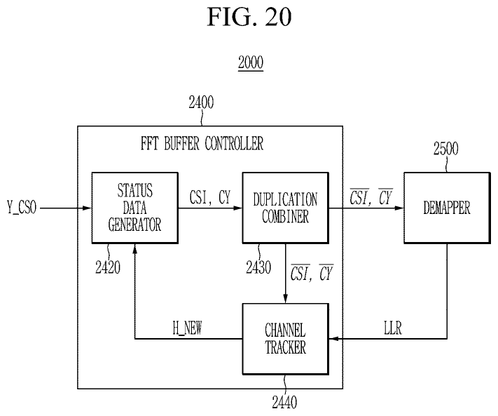

FIG. 20 is the receiver that determines the new channel response value based on a Log Likelihood Ratio (LLR) and the combined status data according to some embodiments. In general, the likelihood ratio is a hypothesis test that involves comparing the fit of two competing statistical models, typically one found by maximization over the entire parameter space and another found after imposing some constraint, based on the ratio of their likelihoods. If the more constrained model (i.e., the null hypothesis) is supported by the observed data, the two likelihoods should not differ by more than sampling error. Thus the likelihood ratio tests whether this ratio is significantly different from one, or equivalently whether its natural logarithm is significantly different from zero.

Referring to FIG. 20, the status data generator 2420 may generate the channel status data CSI and the compensation signal status data CY based on the reception signal Y_CSO with the circular shift order. The duplication combiner 2430 may combine channel status data corresponding to duplication symbols, and may combine the compensation signal status data corresponding to the duplication symbols. The duplication combiner 2430 may provide the combined channel status data C̅S̅I̅ and the combined compensation signal status data C̅Y̅ to the channel tracker 2440 and the demapper 2500.

The demapper 2500 may calculate the Log Likelihood Ratio (LLR) based on the combined channel status data C̅S̅I̅ and the combined compensation signal status data C̅Y̅.

The channel tracker 2440 may determine the new channel response value H_NEW based on the combined channel status data C̅S̅I̅, the combined compensation signal status data C̅Y̅, and the LLR.

The new channel response value H_NEW may be expressed as Equation 13.

$${H}_{i + 1} ( k ) = \{ \begin{matrix}( 1 - μ ) \cdot {H}_{i} ( k ) + μ \cdot \frac{Y ( k )}{\overline{X} ( k )} if all \vert \overline{LLR} ( k , {b}_{j} ) \vert > TH , \\ {H}_{i} ( k ) otherwise .\end{matrix} \qquad ( Equation 13 )$$

Hᵢ₊₁(k) may be the new channel response value of the kth subcarrier. Hᵢ(k) may be a previous channel response value of the kth subcarrier used to generate the channel status data CSI and the compensation signal status data CY. X̅(k) may be a transmission symbol of the kth subcarrier in which a hard decision is performed based on the combined channel status data C̅S̅I̅ and the combined compensation signal status data C̅Y̅. μ may be a smoothing factor. In some embodiments, Hᵢ₊₁(k) may be determined according to an exponential smoothing method where μ is 1/16.

L̅L̅R̅(k, bⱼ) may be the LLR for a jth bit of the kth subcarrier determined based on the combined channel status data C̅S̅I̅ and the combined compensation signal status data C̅Y̅.

In some embodiments, the channel tracker 2440 may determine Hᵢ₊₁(k) calculated according to Equation 13 as the new channel response value H_NEW if the LLR for all bits of the kth subcarrier is greater than or equal to a threshold value (TH). In some embodiments, the channel tracker 2440 may not change the channel response value if the LLR for bits of the kth subcarrier is less than the threshold value (TH).

In some embodiments, the channel tracker may provide the new channel response value H_NEW to the status data generator 2420 if the LLR is greater than or equal to the threshold value (TH). The status data generator 2420 may generate the channel status data CSI and the compensation signal status data CY corresponding to reception symbols included in a reception signal following the reception signal based on the new channel response value H_NEW.

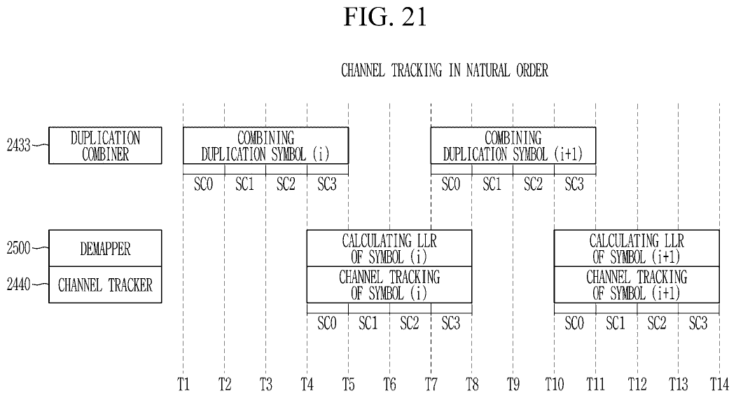

FIG. 21 illustrates operations of the receiver that performs a channel tracking operation based on the reception signal with the natural order according to some embodiments.

In FIG. 21, a case in which status data corresponding to duplication symbols included in the reception signal corresponding to the non-HT DUP MODE with 80 MHz are combined will be described as an example. If the reception signal corresponds to the non-HT DUP MODE with 80 MHz, each of 0th to 3rd subchannels SC0-SC3 with 20 MHz may include the duplication symbols. If the reception signal corresponds to the non-HT DUP MODE with 80 MHz, the number of the duplication symbols may be “4”.

In some embodiments, in a section from T1 to T4, the duplication combiner 2430 of FIG. 20 may receive channel status data with the natural order and compensation signal status data with the natural order, may combine the channel status data corresponding to the duplication symbols, and combine the compensation signal status data corresponding to the duplication symbols. Because each of the 0th to 3rd subchannels SC0-SC3 includes the duplication symbols, the duplication combiner 2430 may provide the combined channel status data, and the combined compensation signal status data to the demapper 2500 after the time point T4 when last duplication symbols are received.

In some embodiments, the demapper 2500 may calculate an LLR after the time point T4 when the combined channel status data and the combined compensation signal status data are received. The channel tracker 2440 of FIG. 20 may receive the LLR from the demapper 2500, and may perform a channel tracking operation that determines the new channel response value based on the LLR, the combined channel status data, and the combined compensation signal status data.

In some embodiments, if the duplication combiner 2430 combines the channel status data with the natural order and the compensation signal status data with the natural order, a time point at which the channel tracker 2440 performs the channel tracking operation determining the new channel response value may be delayed.

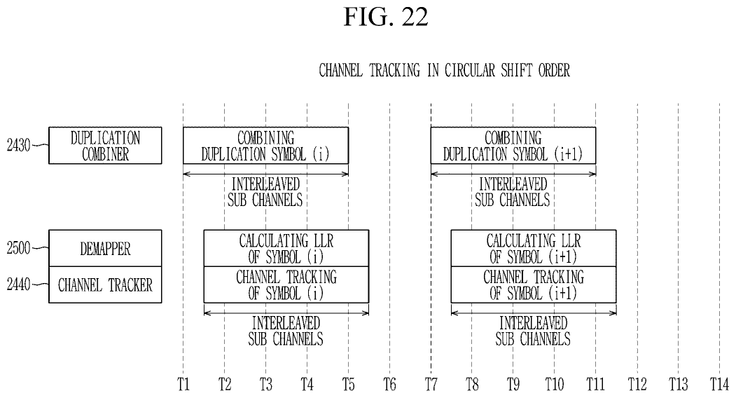

FIG. 22 illustrates operations of the receiver that performs the channel tracking operation based on the reception signal with the circular shift order according to some embodiments.

In FIG. 22, a case in which status data corresponding to duplication symbols included in the reception signal corresponding to the non-HT DUP MODE with 80 MHz are combined will be described as an example.

Referring to FIG. 22, in a section from T1 to T4, the duplication combiner 2430 of FIG. 20 may receive channel status data with the circular shift order and compensation signal status data with the circular shift order. In some embodiments, the duplication combiner 2430 of FIG. 20 may receive the channel status data and the compensation signal status data according to the circular shift order, so that it continuously receives the channel status data and the compensation signal status data corresponding to the duplication symbols.

In some embodiments, in a section from T1 to T2, the duplication combiner 2430 may combine the channel status data and the compensation signal status data corresponding to the duplication symbols, and may output the combined channel status data and the combined compensation signal status data. In some embodiments, the duplication combiner 2430 may output the combined channel status data and the combined compensation signal status data at a faster time point than a time point when the channel status data with the natural order and the compensation signal status data with the natural order are combined.

In some embodiments, the demapper 2500 of FIG. 20 may calculate an LLR from the section from T1 to T2 in which the combined channel status data and the combined compensation signal status data are received. From the section from T1 to T2, the channel tracker 2440 of FIG. 20 may perform a channel tracking operation determining the new channel response value based on the LLR, the combined channel status data, and the combined compensation signal status data.

In some embodiments, a time point at which the channel tracker 2440 performs the channel tracking operation determining the new channel response value of a case in which the duplication combiner 2430 combines the channel status data with the circular shift order and the compensation signal status data with the circular shift order may be faster than a time point at which the channel tracker 2440 performs the channel tracking operation determining the new channel response value of a case in which the duplication combiner 2430 combines the channel status data with the natural order and the compensation signal status data with the natural order.

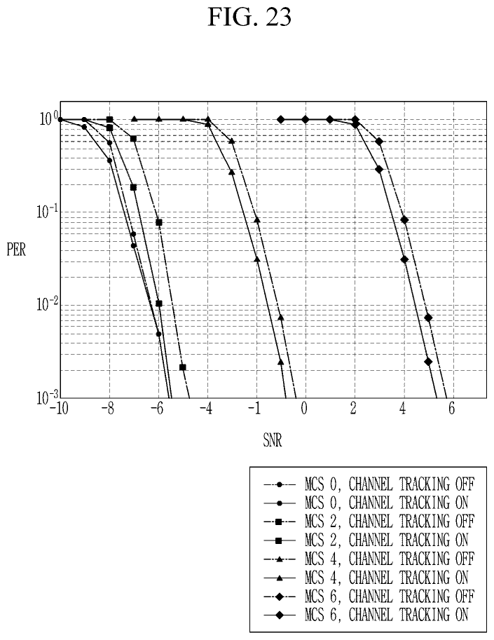

FIG. 23 is a graph of the signal-to-noise ratio (SNR) and a packet error rate (PER) according to the channel tracking operation of some embodiments.

FIG. 23 shows the SNR and the PER according to a case of performing the channel tracking operation and the SNR and the PER according to a case of not performing the channel tracking operation in the non-HT DUP MODE with 320 MHz.

Referring to FIG. 23, in a case of a Modulation Coding Scheme (MCS) 0 method, a difference in the SNR between the case of performing the channel tracking operation and the case of not performing the channel tracking operation at a 10% (10⁻¹) PER may not be large.

In a case of an MCS 2 method, the SNR of the case of performing the channel tracking operation at the 10% (10⁻¹) PER may be 0.8 dB lower than that of the case of not performing the channel tracking operation at the 10% (10⁻¹) PER.

In the case of an MCS 4 method, the SNR of the case of performing the channel tracking operation at the 10% (10⁻¹) PER may be 0.4 dB lower than that of the case of not performing the channel tracking operation at the 10% (10⁻¹) PER.

In the case of an MCS 6 method, the SNR of the case of performing the channel tracking operation at the 10% (10⁻¹) PER may be 0.2 dB lower than that of the case of not performing the channel tracking operation at the 10% (10⁻¹) PER.

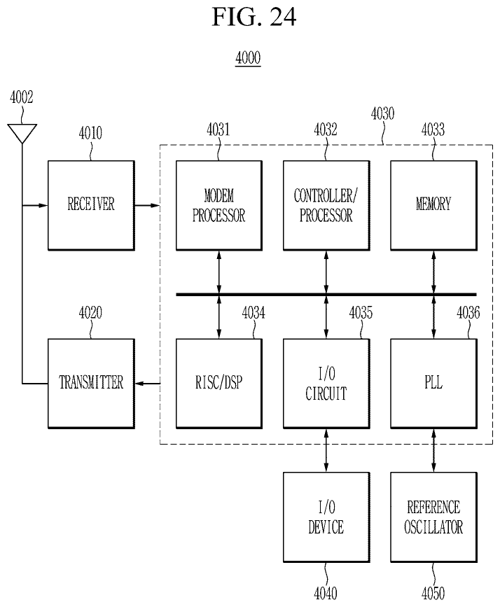

FIG. 24 is a communication device according to some embodiments.

Referring to FIG. 24, the communication device 4000 may include an antenna 4002, a receiver 4010, a transmitter 4020, a communication module 4030, an input/output device 4040, and a reference oscillator 4050. The receiver 4010 may convert a data signal from an analog signal to a digital signal. The transmitter 4020 may convert a data signal received from the communication module 4030 into an analog signal, and then may output the converted data signal to the outside (i.e., external to the communication device 4000) through the antenna 4002.

The communication module 4030 may include a modem processor 4031, a controller/processor 4032, a memory 4033, an RISC/DSP 4034, an input/output device or input/output device circuit 4035, and a phase-locked loop (PLL) 4036.

The modem processor 4031 may perform a processing operation such as encoding, modulation, demodulation, decoding, or the like for data transmission and data reception. In some embodiments, the modem processor 4031 may perform a fast Fourier transform (FFT) operation on a reception signal received from the outside (i.e., external to the communication device 4000), and may control the memory 4033 to store the reception signal according to the natural order. In some embodiments, the modem processor 4031 may control the memory 4033 to read the reception signal with the natural order stored in the memory 4033 according to the circular shift order. The controller/processor 4032 may control blocks within the communication module 4030. The memory 4033 may store data and various instruction codes. The RISC/DSP 4034 may perform a general or specialized processing operation in the communication device 4000. The input/output device 4035 may communicate with an external input/output device 4040. The phase-locked loop 4036 may perform a frequency modulation operation using a frequency signal received from the reference oscillator 4050. The reference oscillator 4050 may be implemented as a crystal oscillator (XO), a voltage-controlled crystal oscillator (VCXO), a temperature compensated crystal oscillator (TCXO), or the like. The communication module 4030 may perform a processing operation required for communication using an output signal generated at the phase-locked loop 4036.

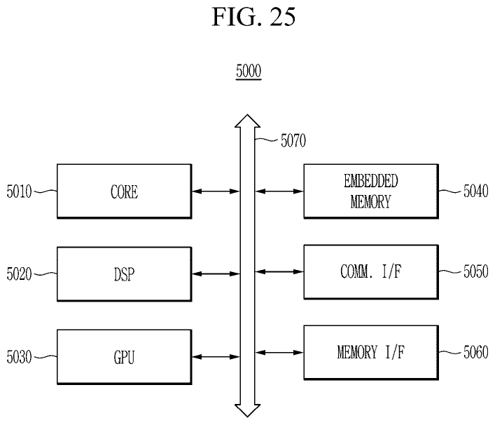

FIG. 25 is a system-on-chip according to some embodiments.

A system-on-chip (SoC) 5000 may be referred to as an integrated circuit in which components of a computing system or another electronic system are integrated. For example, an application processor (AP) included in the system-on-chip 5000 may include components for a processor and other functions.

Referring to FIG. 25, the system-on-chip 5000 may include a core 5010, a digital signal processor (DSP) 5020, a graphics processing unit (GPU) 5030, an embedded memory 5040, a communication interface 5050, and a memory interface 5060. Components of the system-on-chip 5000 may communicate with each other through a bus 5070.

The core 5010 may process commands, and may control operations of components included in the system-on-chip 5000. For example, the core 5010 may drive an operating system and may execute applications on the operating system by processing a series of commands. The DSP 5020 may generate useful data by processing a digital signal (e.g., a digital signal provided from the communication interface 5050)

In some embodiments, the DSP 5020 may perform a fast Fourier transform (FFT) operation on a reception signal received from the outside (i.e., external to the DSP 5020 or external to the system-on-chip 5000, and may control the embedded memory 5040 to store the reception signal according to the natural order. In some embodiments, the DSP 5020 may control the embedded memory 5040 to read the reception signal with the natural order stored in the embedded memory 5040 according to the circular shift order. The GPU 5030 may generate data for an image output through a display device from image data provided from the embedded memory 5040 or the memory interface 5060, and may encode the image data. The embedded memory 5040 may store data necessary for the core 5010, the DSP 5020, and the GPU 5030 to operate. The memory interface 5060 may provide an interface for an external memory (e.g., a dynamic random access memory (DRAM), a flash memory, or the like) of the system-on-chip 5000.

The communication interface 5050 may provide serial communication with the outside of the system-on-chip 5000. For example, the communication interface 5050 may be connected to Ethernet, and may include SerDes for serial communication.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A receiver comprising:
a fast fourier transform (FFT) processor configured to receive a signal including a plurality of first symbols, and configured to output a plurality of second symbols corresponding to a result of performing a fast fourier transform operation on the signal;
a FFT reorder buffer memory configured to store a plurality of third symbols in which the plurality of second symbols are reordered according to a natural order; and
a FFT buffer controller configured to control the FFT reorder buffer memory to read the plurality of third symbols according to a circular shift order in which bits of addresses of the FFT reorder buffer memory are circularly shifted.

2. The receiver of claim 1, wherein the plurality of first symbols corresponds to the natural order, and the plurality of second symbols corresponds to a bit-reversed order.

3. The receiver of claim 1, wherein the FFT buffer controller comprises an address generator configured to determine a number of bits of the addresses based on a size of FFT determined according to a type of the signal and a bandwidth of the signal.

4. The receiver of claim 3, wherein the address generator comprises a bit circular shift circuit configured to determine a number of bits circularly shifted among the bits of the addresses based on a number of duplication symbols included in the plurality of third symbols.

5. The receiver of claim 4, wherein the address generator comprises an address counter configured to generate the addresses according to the natural order, and
wherein the bit circular shift circuit is configured to convert the addresses received from the address counter into addresses with the circular shift order, and provide the addresses with the circular shift order to the FFT reorder buffer memory.

6. The receiver of claim 1, wherein the FFT buffer controller comprises a status data generator configured to receive a plurality of fourth symbols reordered according to the circular shift order, generate first status data corresponding to each of the plurality of fourth symbols based on the plurality of fourth symbols and a channel response value, generate second status data obtained by squaring the channel response value, and output the first status data and the second status data according to the circular shift order.

7. The receiver of claim 6, wherein the FFT buffer controller comprises a duplication combiner configured to generate combined first status data corresponding to duplication symbols among the plurality of fourth symbols, and generate combined second status data corresponding to the duplication symbols.

8. The receiver of claim 7, wherein the duplication combiner comprises:
a multiplexer configured to select the first status data or the second status data corresponding to the duplication symbols;
a summer configured to combine the first status data or the second status data corresponding to the duplication symbols into combined first status data or combined second status data; and
a divider configured to divide the combined first status data or the combined second status data by a number of the duplication symbols.

9. The receiver of claim 8, further comprising:
a demapper configured to calculate a Log Likelihood Ratio (LLR) of each of the plurality of fourth symbols based on the combined first status data and the combined second status data, and
wherein the FFT buffer controller comprises a channel tracker configured to determine a new channel response value based on the LLR, and the combined first status dataor the combined second status data.

10. The receiver of claim 9, wherein the status data generator is configured to generate the first status data and the second status data respectively corresponding to a plurality of symbols included in a signal following the signal based on the new channel response value.

11. A receiver comprising:
a fast fourier transform (FFT) processor configured to receive a signal including symbols with a natural order and configured to output symbols with a bit-reversed order corresponding to a result of performing a fast fourier transform operation on the signal; and
a FFT buffer controller configured to reorder the symbols with the bit-reversed order into symbols with a circular shift order, generate status data of each of the symbols with the circular shift order, and combine status data of duplication symbols among the symbols with the circular shift order.

12. The receiver of claim 11, further comprising:
a FFT reorder buffer memory configured to store symbols with the natural order in which the symbols with the bit-reversed order are reordered in the natural order.

13. The receiver of claim 12, wherein the FFT buffer controller comprises a bit reversal circuit configured to generate addresses with the bit-reversed order in which bits of addresses with the natural order are reversely ordered, and
wherein the FFT reorder buffer memory is configured to store the symbols with the bit-reversed order according to the natural order based on the addresses with the bit-reversed order.

14. The receiver of claim 12, wherein the FFT buffer controller is configured to control the FFT reorder buffer memory to read the symbols with the natural order stored in the FFT reorder buffer memory according to addresses with the circular shift order in which bits of addresses with the natural order are circularly shifted.

15. The receiver of claim 14, wherein the FFT buffer controller comprises a bit circular shift circuit configured to circularly shift at least one bit determined based on a number of the duplication symbols among the bits of the addresses with the natural order.

16. The receiver of claim 11, wherein the FFT buffer controller comprises a status data generator configured to generate the status data according to the circular shift order.

17. The receiver of claim 16, further comprising:
a demapper configured to calculate a Log Likelihood Ratio (LLR) of the symbols with the circular shift order based on the combined status data,
wherein the FFT buffer controller is configured to determine a new channel response value based on the combined status data when the log likelihood ratio is greater than a threshold value, and
wherein the status data generator includes a channel tracker configured to change a channel response value used to generate the status data to the new channel response value.

18. A communication system comprising:
a transmitter configured to transmit a signal including a plurality of symbols; and
a receiver configured to receive the signal, perform a fast fourier transform (FFT) operation on the signal, reorder the plurality of symbols included in the signal according to a circular shift order, generate status data of each of the plurality of symbols according to the circular shift order, and generate combined status data corresponding to duplication symbols among the plurality of symbols.

19. The communication system of claim 18, wherein the receiver comprises:
a FFT reorder buffer memory configured to store the plurality of symbols; and
a FFT buffer controller configured to convert addresses of the FFT reorder buffer memory into addresses with the circular shift order, and control the FFT reorder buffer memory to read the plurality of symbols according to the addresses with the circular shift order.

20. The communication system of claim 19, wherein the FFT buffer controller comprises a bit circular shift circuit configured to determine a number of bits to be circularly shifted among bits of the addresses of the FFT reorder buffer memory based on a number of the duplication symbols.
